(19) United States
(12) Patent Application Publication
(10) Pub. No.: US 2003/0102016 A1
(43) Pub. Date: Jun. 5, 2003

(54) Integrated circuit processing system

(76) Inventor: Gary Bouchard, Santa Cruz, CA (US)

Correspondence Address: BEYER WEAVER & THOMAS LLP, P.O. BOX 778, BERKELEY, CA, 94704-0778, US

(21) Appl. No.: 10/227,163

(22) Filed: Aug. 22, 2002

Related U.S. Application Data
(60) Provisional application No. 60/337,067, filed on Dec. 4, 2001.

(51) Int. Cl. B08B 1/02; B08B 3/00

(52) U.S. Cl. 134/32; 134/95.2; 134/104.2; 134/137

(57) ABSTRACT

An apparatus and method for conveying integrated circuits is disclosed. The method includes providing a plurality of integrated circuits. The method further includes capturing the integrated circuits. The method additionally includes sliding the integrated circuits along a surface. The method also includes substantially retaining the integrated circuits relative to the surface so as to keep the integrated circuits in a desired movement path as they are slid along the surface.

### CROSS REFERENCE TO RELATED APPLICATION

This application claims the priority of U.S. Provisional Patent Application No. 60/337,067 entitled “Substrate Processing System”, filed on Dec. 4, 2001 and which is incorporated herein by reference.

This application is related to U.S. patent application Ser. No.: ______, (Attorney Docket No.: ICONP005), entitled “High Speed Pickhead”, filed on even date and which is incorporated herein by reference.

### FIELD OF THE INVENTION

The invention generally relates to integrated circuit processing equipment. More particularly, the invention relates to a singulation and transfer system for chip scale packages.

### BACKGROUND OF THE INVENTION

In brief, chip scale packages (CSP) refer to a packaging technology that allows an integrated circuit to be attached to a printed circuit board face-down, with the chip's contacts connecting to the printed circuit board's contacts through individual balls of solder. During fabrication thereof, multiple integrated circuit chips (ball grid arrays and dies) are formed on a single substrate (e.g., wafer or circuit board), and thereafter separated into a plurality of individual or single integrated circuit chips. Although a substrate may be separated at substantially any point during an overall fabrication process, the substrate is typically separated after the ball grid arrays and dies are formed on the substrate.

FIGS. 1A and 1B are top views of a conventional substrate 1 (e.g., carrier or strip) and a plurality of chip scale packages 2 showing the contact, or ball grid array (BGA) side of the substrate and chips rather than the die side of the chips. FIG. 1A is a top view of the substrate 1 with the chips 2 formed thereon. FIG. 1B, on the other hand, is a top view of the chips 2 after separation from the substrate 1. As shown, the substrate 1 includes individual chips 2, each of which includes a ball grid array of contacts. The number of chips 2 formed on substrate 1 generally depends on the size of the substrate 1 and the size of each of the chips 2. Furthermore, the number of balls in each of ball grid arrays generally varies according to the specific needs of the chip 2. FIG. 1C is a side view of a separated chip 2. As shown, one side of the chip 2 has a ball grid array 3, while the other side has a die 4. As should be appreciated, the die side of the chip is generally considered the “smooth side” of the chip since it does not include contacts or balls, i.e., the die side is substantially flat.

Conventionally, a singulation procedure is performed to separate the chips from the substrate. Singulation may include sawing (or dicing), stamping, water jet cutting and laser singulation. The most common of these methods is sawing. During sawing, the substrate is typically held in place while one or more saw blades cut through the substrate to form the individual chips. The substrate may be held by an adhesive tape and/or by a vacuum chuck.

After singulation, post processing steps are generally performed. During these steps, the chips are typically transported through various process regions. The transportation may be performed using nests, holding trays, pick-and-place machines, conveyors, belt drives, etc. The holding trays and nests typically include spaces for retaining a plurality of individual chips. As such, a plurality of chips may be transported at one time. In some cases, the chips are manually placed in the holding trays and in other cases the chips are automatically placed in the holding trays. Pick-and-place machines generally refer to machines that automatically pick and place the chips with suction cups or mechanical grippers and pneumatic or motor control. For example, they may pick and place parts relative to holding trays or other surfaces.

Although these systems work well, there are desired improvements that increase throughput, reduce costs and minimize changeover tooling.

### SUMMARY OF THE INVENTION

The invention relates, in one embodiment, to a method of conveying integrated circuits. The method includes providing a plurality of integrated circuits. The method also includes capturing the integrated circuits. The method further includes sliding the integrated circuits along a surface. In some cases, the method further includes substantially retaining the integrated circuits relative to the surface so as to keep the integrated circuits in a desired movement path as they are slid along the surface.

The invention relates, in another embodiment, to a process of making an integrated circuit. The method includes providing a plurality of integrated circuits. The method also includes sliding the integrated circuits along a surface. The method additionally includes performing a processing step on the integrated circuits.

The invention relates, in another embodiment, to a chip scale package processing system. The system includes a singulation station configured to dice a substrate into a plurality of chip scale packages, each of the chip scale packages having a smooth side. The system also includes a cleaning station configured to remove any debris that adhered to the chip scale packages during singulation. The system further includes a buffer station configured to provide a conveying area for the chip scale packages. The method additionally includes a transfer arrangement configured to transport the chip scale packages through and between the various stations. The smooth side of the chip scale packages are slid along a surface during transport.

The invention relates, in another embodiment, to a cleaning station for use in an integrated circuit processing system. The cleaning station includes a wash assembly capable of distributing a fluid for washing integrated circuits that are moved along a washing surface. The cleaning station also includes a dry assembly capable of removing moisture from integrated circuits that are moved along a drying surface.

The invention relates, in another embodiment, to a holding platform configured to allow movements of integrated circuits thereon, and to provide a retention force that helps maintain the moving integrated circuits in a desired position relative to one another during movements thereof.

The invention relates, in another embodiment, to a dual vacuum chuck assembly for holding a pair of substrates and the integrated circuits formed therefrom before, during and after a singulation procedure. The assembly includes a first vacuum chuck having a first contact surface for receiving a first substrate. The first contact surface includes a plurality of openings that provide a vacuum therethrough for holding the first substrate and the integrated circuits formed therefrom. Each of the plurality of openings corresponds to an individually singulated integrated circuit. The first contact surface is configured to allow the integrated circuits to move thereon absent a substantial vacuum through the plurality of openings. The assembly also includes a second vacuum chuck having a second contact surface for receiving a second substrate. The first contact surface includes a plurality of second openings that provide a vacuum therethrough for holding the second substrate and the integrated circuits formed therefrom. Each of the plurality of second openings corresponds to an individually singulated integrated circuit. The second contact surface is configured to allow the integrated circuits to move thereon absent a substantial vacuum through the plurality of second openings.

### BRIEF DESCRIPTION OF THE DRAWINGS

The invention may best be understood by reference to the following description taken in conjunction with the accompanying drawings in which:

FIG. 1A is a diagrammatic representation of a conventional substrate.

FIG. 1B is a diagrammatic representation of the chips formed from the substrate of FIG. 1A after singulation from the substrate.

FIG. 1C is a side view of a singulated chip having a ball grid array on one side and a smooth surface of the substrate on the other.

FIG. 2 is a simplified block diagram of a substrate processing system, in accordance with one embodiment.

FIGS. 3A and 3B are perspective diagrams of a substrate processing system, in accordance with one embodiment of the present invention.

FIG. 4 is a flow diagram illustrating a processing sequence of a substrate processing system, in accordance with one embodiment of the present invention.

FIG. 5A is a side view of a dual chuck assembly, in accordance with one embodiment of the present invention.

FIG. 5B is a top view of a dual chuck assembly, in accordance with one embodiment of the present invention.

FIGS. 6A-6E are simplified diagrams showing the movements of a transfer arm, in accordance with one embodiment of the present invention.

FIG. 7A is a side view of a cleaning station, in accordance with one embodiment of the present invention.

FIG. 7B is a top view of a cleaning station, in accordance with one embodiment of the present invention.

FIG. 8 is a side elevation view of a transfer arm for moving the chips across a cleaning station, in accordance with one embodiment of the present invention.

FIG. 9 shows a pressurized fluid attacking a smooth side of a single chip, in accordance with one embodiment of the present invention.

FIG. 10A is a side view of a holding platform, in accordance with one embodiment of the present invention.

FIG. 10B is a top view of a holding platform, in accordance with one embodiment of the present invention.

FIG. 11A is a top view of a transfer arm moving a plurality of grouped chips along a surface, in accordance with one embodiment of the present invention.

FIG. 11B is a top view of a transfer arm moving a plurality of chip rows along a surface, in accordance with one embodiment of the present invention.

FIG. 11C is a top view of a transfer arm moving a single group of chips, in accordance with one embodiment of the present invention.

FIG. 11D is a top view of a row indexer moving distinct rows of chips, in accordance with one embodiment of the present invention.

FIG. 11E is a top view of a row indexer moving distinct rows of chips, in accordance with one embodiment of the present invention.

### DETAILED DESCRIPTION OF THE INVENTION

The invention generally pertains to a system capable of processing and conveying products associated with integrated circuits (e.g., dies, unpackaged chips, packaged chips, and the like). By processing, it is meant methods used to produce the finalized product. By way of example, the term processing may encompass singulation, cleaning, inspection, and the like. Processing may also encompass methods used to form or create an integrated circuit such as forming a die, attaching the die to a substrate, forming contacts on the die, packaging the die, and so on. By conveying, it is meant methods used to move parts from one place to another before, during and/or after processing steps. By way of example, the term conveying may encompass transporting, transferring, loading, unloading, sorting, grouping, and the like. The system described herein is particularly suitable for processing and conveying surface mount devices such as chip scale packages or ball grid arrays (BGA).

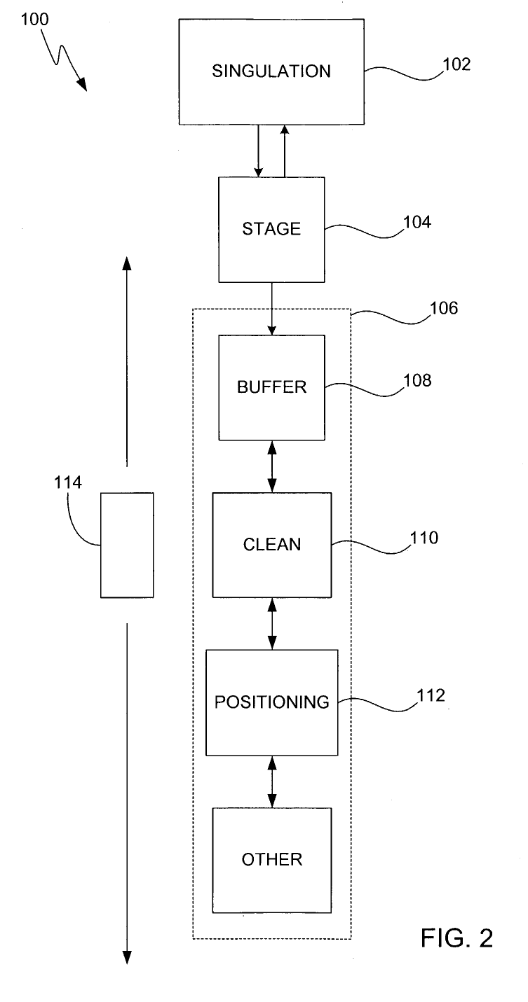

Embodiments of the invention are discussed below with reference to FIGS. 2-11. However, those skilled in the art will readily appreciate that the detailed description given herein with respect to these figures is for explanatory purposes as the invention extends beyond these limited embodiments. For ease of explanation, the below description refers to a system that processes and conveys chip scale packages. It should be noted, however, that the invention is applicable to all devices described herein.

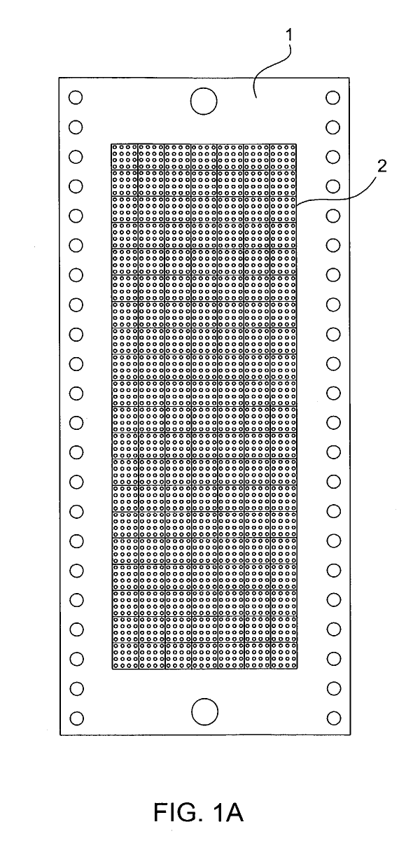

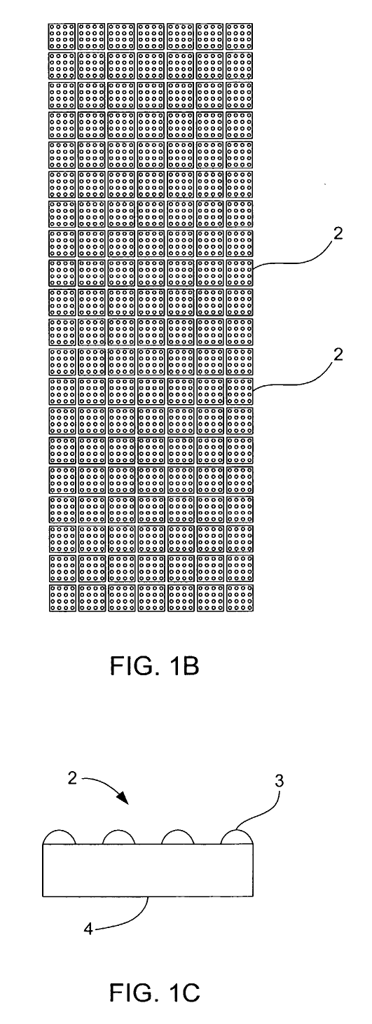

FIG. 2 is a simplified block diagram of a substrate processing system 100, in accordance with one embodiment. The substrate processing system 100 may be used to process packaged devices contained on a strip, carrier or substrates of various types including circuit boards, film, metal on ceramic based substrates, and the like. For example, the substrate processing system may be used to process the strip shown in FIG. 1A. The substrate processing system 100 generally includes a singulation subsystem 102 where the strip of packaged devices is singulated so as to produce a plurality of individual chips (see FIGS. 1B and 1C).

The singulation subsystem 102 may be widely varied. For example, sawing or punch die methods may be used. Other non conventional methods such as laser cutting and pressurized water cutting may also be used. In one particular embodiment, the singulation subsystem 102 corresponds to a sawing method. During sawing one or more cutting blades are used to dice the strip into a plurality of chips. The cutting blades may be configured to make a single pass or multiple passes during the singulation procedure in order to singulate the entire substrate. In general, more blades equates to a decreased cycle time. Therefore, a plurality of cutting blades is typically used in parallel in order to decrease the cycle time of the system. For example, the saw may include two or more cutting blades positioned side by side with gaps therebetween corresponding to the desired width of the singulated chip. In one implementation, the substrates contain chip scale packages having ball grid arrays disposed thereon. These packages are generally singulated ball side up.

The substrate processing system 100 also includes a stage subsystem 104 where the strip of packaged devices are held during the singulation procedure. The plurality of singulated chips are also held in the stage subsystem 104 while waiting for further processing. In one embodiment, the stage subsystem 104 includes a chuck for holding one or more substrates (as well as the singulated chips formed therefrom), and a chuck table for moving the substrate and the singulated chips to and from the singulation subsystem 102. The chuck table may also move the substrate during the singulation procedure in order to singulate the entire substrate. For example, the chuck table may rotate 90 degrees in order to allow cuts in two directions (e.g., X and Y) and it may translate through the saw blades so as to implement sawing. The chuck may be widely varied. For example, the chuck may be a mechanical, vacuum or electrostatic chuck (or the like). In the case where substrates with ball grid arrays are used, the vacuum chuck is arranged to apply suction to the smooth side of the substrate during and after singulation. A chuck is described in greater detail below.

The substrate processing system also includes a post singulation subsystem 106 where the singulated chips are further processed. The post singulation subsystem 106 may be widely varied. For example, the post singulation subsystem 106 may include buffer stations 108, cleaning stations 110, positioning stations 112, and/or the like, as well as transfer units 114 for moving the chips through the various stations. Buffer stations 108 generally relate to areas used to store the chips between two different processings thereof. For example, a buffer station 108 may be used to store chips after singulation, but before cleaning. Cleaning stations 110 generally related to areas used to wash and dry the chips. As should be appreciated, particles or debris may adhere to the singulated chips and thus they need to be cleaned. Positioning stations 112 generally relate to areas used to reposition the chips, as for example, for grouping chips together, for separating them or for moving them to a desired location.

In one embodiment, the transfer unit 114 is arranged to slide the chips through one or more of the stations. This may be accomplished by a transfer arm that pushes or pulls on the sides of the chip or chips. Such units are described in greater detail below. In the case of chip scale packages, the chips are generally dragged along their smooth side (i.e., ball side up). In one implementation, the transfer arm may be configured to push or pull the chips through a single processing station. For example, the transfer arm may push or pull the chips through a buffer station, cleaning station, positioning station and/or the like. In another implementation, the transfer arm may be configured to push or pull the chips from the stage block to a processing station. For example, the transfer arm may push or pull the chips from the chuck of the stage block to a buffer station so as to allow a new set of substrates to be placed on the chuck (thereby decreasing cycle time). In another implementation, the transfer arm may be configured to push or pull the chips from a first processing station to a second processing station. For example, the transfer arm may push or pull the chips from a buffer station to a cleaning station, from a cleaning station to a positioning station, from a first positioning station to a second positioning station, or the like. With regards to the two later implementations, the surfaces of the adjacent stations are generally level so as to allow the chips to slide without impediments (e.g., raised or lowered surfaces). It should be noted, however, that this is not a limitation and that other transfer arms may be used to bypass non-level surfaces. Furthermore, it should be noted that the surfaces may be angled relative to one another.

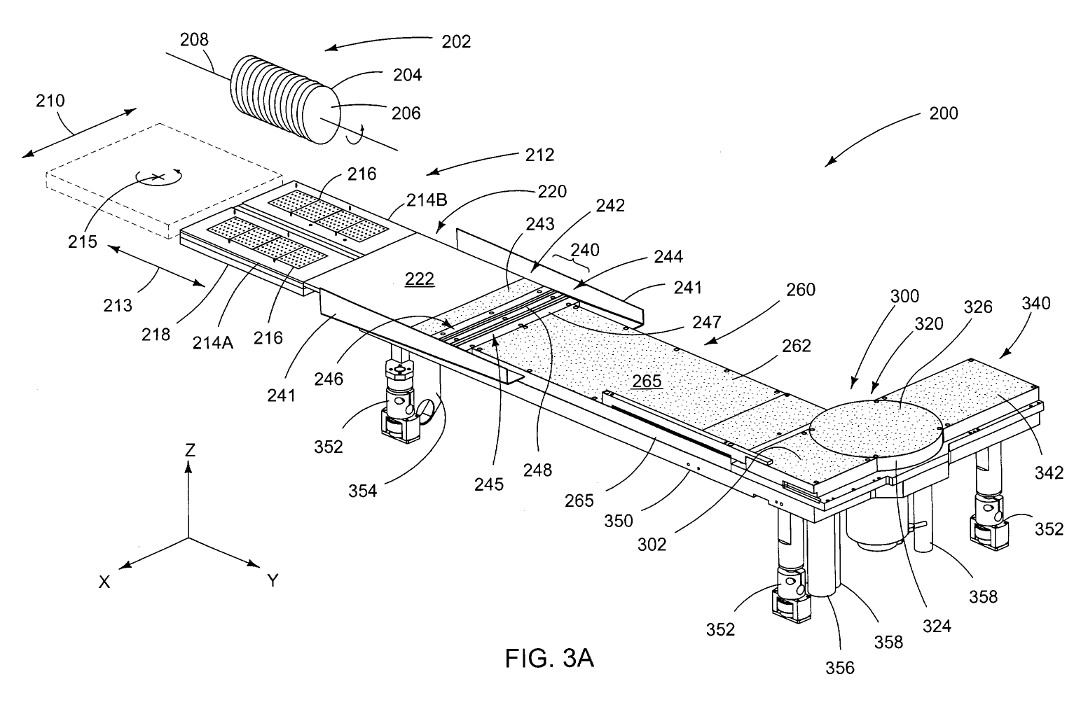

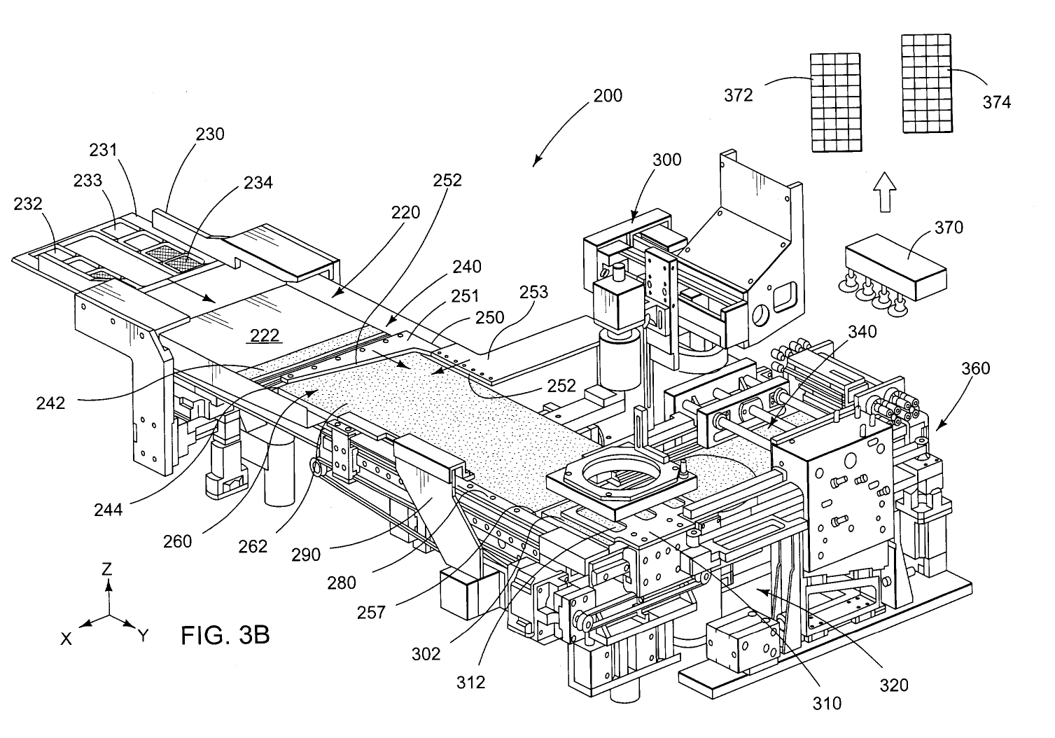

FIGS. 3A and 3B are perspective diagrams of a substrate processing system 200, in accordance with one embodiment of the present invention. By way of example, the substrate processing system 200 may generally correspond to the substrate processing system 100 shown in FIG. 2. In one embodiment, the substrate processing system is arranged to process chip scale packages (CSP). The chip scale packages are generally disposed on a substrate, strip, carrier or the like in rows and columns before singulation.

The substrate processing system 200 includes a singulation assembly 202 for singulating one or more substrates (for example, as shown in FIG. 1A) into a plurality of chips (for example, as shown in FIG. 1B). In the illustrated embodiment, the singulation assembly includes a saw 204 having a plurality of cutting blades 206. The cutting blades 206 are arranged to rotate about an axis 208 so as to dice the substrate in the direction 210. The number of blades, as well as the direction of dicing, may be widely varied. The number of blades may generally correspond to the number of chips located in the rows or columns of chips disposed on the substrate. For example, in a ten by ten array the saw assembly may include at least 10 blades. This is not a requirement, however, and the number of blades may vary according to the specific needs of each device, i.e., there may be fewer blades than rows of chips or there may be more blades than rows of chips. In the case where there are fewer blades than chips, the system may be arranged to make more than one pass in order to complete the cutting of the substrate in the direction 210. Saws such as these are well known in the industry and for the sake of brevity will not be described in any greater detail.

The substrate processing system 200 also includes a chuck assembly 212. The chuck assembly 212 is generally arranged to hold one or more substrates and diced chips formed therefrom before, after and during dicing. The chuck assembly 212 is also arranged to move the substrates and diced chips for loading and unloading. In one implementation, the chuck assembly moves between an initial position (as shown) where one or more new substrates to be processed may be received and where the diced chips may be removed, and a singulation position where a singulation procedure may be performed (shown by the dotted lines). For example, the chuck assembly may move in the direction of axis 213 (in the Y direction).

When the chuck assembly 212 is in the singulation position (dotted lines), the chuck assembly 212 is further configured to move so as to perform the singulation procedure (dice the one or more substrates into a plurality of chips). For example, the chuck assembly may translate towards the cutting blades 206 of the saw assembly 204 in order to implement dicing. That is, the chuck assembly moves along axis 210 thereby feeding the substrates into the array of saw blades and effecting singulation (e.g., causing the blades to cut through the substrates that are held on the chuck assembly 212). In one implementation, the chuck assembly translates between a first position (e.g., singulation position) and a second position in order to move the substrates through the blades. Alternatively, the blades may be translated in order to dice the substrates. In addition, the blades may be rotated 90 degrees so that its axis of rotation is parallel to the direction 210 thereby allowing the chuck assembly to only translate in the direction 213 to implement dicing.

In addition, the chuck assembly 212 may rotate in order to allow cuts in multiple directions on the substrates. For example, the chuck assembly 212 may be configured to rotate between a first rotate position, placing the substrates in a first cut direction, and a second rotate position, placing the substrate in a second cut direction. In most cases, the first set of cuts is orthogonal to the second set of cuts (e.g., 90 degrees) so as to produce square or rectangular chips. The chuck assembly 212 generally rotates when the chuck assembly is in the singulation position.

An exemplary process using the above arrangement may include 1) carrying one or more substrates from the initial (as shown) to the cutting position (shown by dotted lines) via the chuck assembly 212, 2) making a first set of cuts on the substrates via the saw 204 and a translating chuck assembly 212, 3) rotating the substrates from the first rotation position to the second rotation position via a rotating chuck assembly 212, 4) making a second set of cuts on the substrates with the saw 204 and a translating chuck assembly 212, 5) rotating the diced chips back to the pre rotation position via a rotating chuck assembly 212, and 6) carrying the diced chips back to the initial position via the chuck assembly 212.

The chuck assembly 212 may be widely varied. For example, the chuck assembly may include a single chuck for holding a single substrate, or it may include a plurality of chucks for holding a plurality of substrates. It is generally believed that increasing the number chucks decreases the cycle time of the system, i.e., more substrate may be diced for a given time. In the illustrated embodiment, the chuck assembly 212 includes two chucks 214A and 214B. Each of the chucks 214 is arranged to hold an individual substrate. By having two chucks, two substrates may be handled at the same time and thus the step of placing a second substrate and removing the first substrate may be removed. That is, two substrates may be singulated while the chuck assembly 212 is translating (e.g., in the cutting position) thereby decreasing the handling time associated with handling one substrate at a time. For example, the time it takes to translate and rotate the chuck assembly as well as the time it takes to receive and remove the substrate and chips to and from the chuck assembly. In one embodiment, each of the chucks 214 is configured to provide a vacuum in order to hold the substrate and diced chips before, after and during dicing. In this particular embodiment, each of the chucks 214 is configured to include a vacuum platform 216 and a vacuum chamber (not shown) disposed underneath the vacuum platform 216.

The vacuum platform 216 is generally configured to receive the substrate and chips. For example, the vacuum platform 216 may be configured to receive the smooth side of the substrate and chips so as to place the ball grid array of a CSP in an upwards position for singulation. The vacuum platform 216 generally includes a plurality of openings, each of which may correspond to one of the singulated chips. That is, the vacuum platform 216 includes an opening that applies a vacuum to each chip to be singulated. In one implementation, the vacuum platform 216 includes a rubberized surface. The rubberized surface is configured to provide a certain amount of friction with regards to moving the substrate and chips planarly along the surface of the vacuum platform 216 during the singulation procedure. The rubberized surface is also configured to allow the diced chips to be slid therefrom after the singulation procedure. The rubberized surface is also configured to be deformable so as to provide a surface with sealing capablities, i.e., when a vacuum is applied to the smooth side of the chip through the opening the deformable surface tends to deform to the edge of the smooth side of the chip thus sealing the vacuum. Although the term “rubberized” is used, it should be noted that the vacuum platform is not limited to rubber materials, but to materials that may have at least one of the elements described above. The vacuum chamber 218, on the other hand, is generally configured to supply a vacuum to each of the openings of the vacuum platform 216. In most cases, the vacuum chamber 218 includes a housing that defines a void therein that is fluidly coupled to the openings of the vacuum platform 216 and a vacuum source (not shown). Some aspects of the vacuum platform are described in U.S. Pat. No. 6,325,059, which is herein incorporated by reference.

It should be noted that holding a pair of substrates is not a limitation. For example, the dual chuck may also be used to support one extremely long and/or one wide substrate rather than two normal sized substrates. In addition, the dual chuck may be used to support several small substrates rather than two normal sized substrates. It should also be noted that a dual chuck is not a limitation. For example, the chuck assembly may include a single chuck or more than two chucks. Furthermore, the chuck may also include dowel and alignment pins for aligning the substrate thereon.

Although not shown, the system may include a cassette onload or stack magazine onload that feeds the one or more substrates to a substrate conveyor that presents the one or more substrates to a chuck loader. The chuck loader generally picks up one or more substrates from the substrate conveyor and places them on the chuck assembly 212. Upon placement, the chuck loader may provide enough downward force, via air cylinder clamping pads, to ensure that the substrate is secure in the chuck assembly 212 (mold distortion has been over come and vacuum is made). Such systems are well known in the art.

The substrate processing system 200 also includes a buffer station 220. The buffer station 220 is generally arranged to provide a buffer area for removing the diced chips from the chuck assembly 212. In one embodiment, the buffer station 220 serves as a space for getting the diced chips off of the chuck assembly 212 so that more chips may be singulated. That is, by moving the separated dies to the buffer station 220, a new set of substrates may be loaded on the chuck assembly 212 thereby reducing handling time. For example, as soon as the chips are moved onto the buffer station 220, two more substrates may be placed on the chuck assembly 212 via the chuck loader (not shown). The chuck loader generally waits patiently with a new set of substrates until the diced chips are moved away. In most cases, as soon as the chips are removed, the chuck loader places the substrates on the chuck assembly 212.

The buffer station 220 generally includes a buffer platform 222 that is arranged to abut the chuck assembly 212 when the chuck assembly 212 is placed in its initial position (as shown). In one embodiment, the chips are slid from the surface of the chuck assembly 212 to the buffer platform 222. For example, in the case of CSP's, the smooth side of the chip is slid along the top surface of the chuck assembly 212 and the buffer platform 222. In this embodiment, both the chuck assembly 212 and the buffer platform 222 are configured to provide planar surfaces that are level with one another, i.e., the planar surface are flush. By providing level surfaces, the chips may be easily slid from the chuck assembly 212 to the buffer platform 222, i.e., without snags.

The substrate processing system 200 also includes a cleaning station 240. The cleaning station 240 is configured to remove any debris or residue that adhered to the chips during dicing. The cleaning station 240 includes a wash assembly 242 and a dry assembly 244. The wash assembly 242 is configured to provide a cleaning solution that cleans debris from parts. The wash assembly 242 may be widely varied. For example, the wash assembly 242 may include solution injectors for injecting a solution at various pressures (high, medium, low) on the chips. The solution may be distributed from the top, side, and/or bottom of the chips during a cleaning cycle. Furthermore, the injectors may be stationary or they may be capable of moving so as to ensure that a substantial portion of the chip is cleaned.

In the illustrated embodiment, the wash assembly 242 includes a solution holding tank (not shown in FIG. 3) and a solution distribution plate 243 capable of distributing a substantially uniform solution to the chips. The solution distribution plate 243 generally includes a plurality of holes configured to flow the solution therefrom. The amount of flow is generally dependent on the flow needed to clean the part. In one implementation, the plurality of holes are arranged to produce a low flow fluid above the surface of the plate 243 so as to loosen and float any sawing slurry residue that remains trapped under the chips.

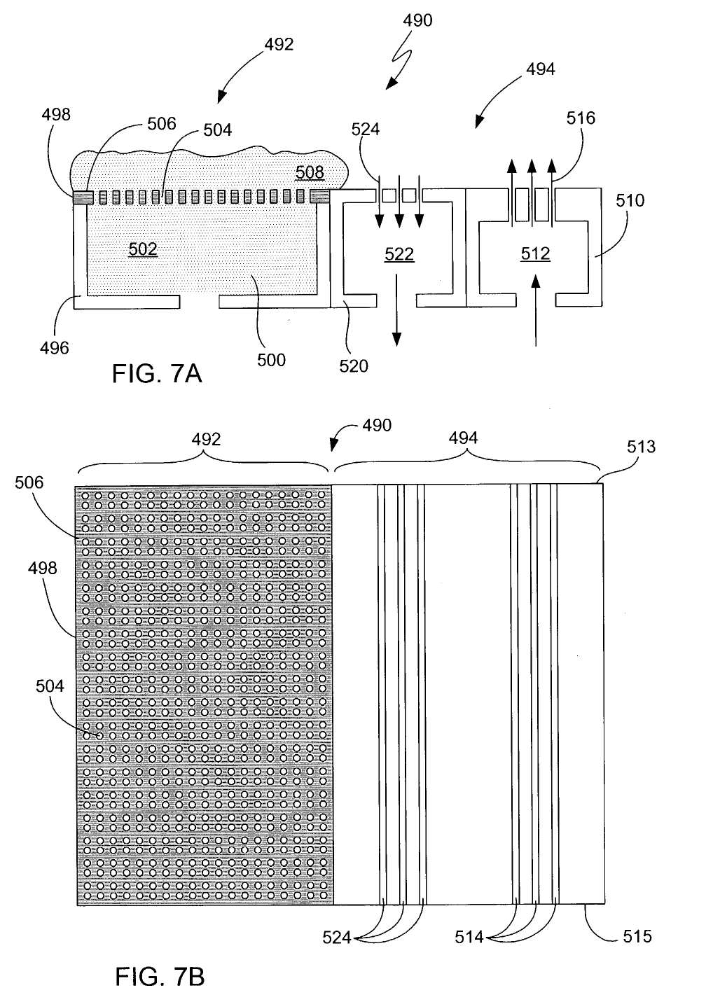

In one embodiment, the chips are slid through the wash assembly 242. For example, in the case of CSP's, the smooth side of the chip is slid along the solution distribution plate 243. In this embodiment, the chips may be submerged during movement through the wash assembly 242. In most cases, the solution distribution plate 243 is configured to provide planar surface that is level with the planar surface of the buffer platform 222. An example of this type of wash assembly is shown in FIGS. 7A and 7B.

Moreover, the wash assembly 242 may include a tray or gutter 241 for collecting the solution after it has been used to clean the chips. The gutter 241 may be positioned to the side of the solution distribution plate 243 to capture the solution as it flows over the sides of the solution distribution plate 243.

The dry assembly 244, on the other hand, is configured to substantially remove the cleaning solution from the plurality of chips, i.e., to remove moisture from the plurality of chips so that the chips exude an acceptable dry condition. In one embodiment, the dry assembly 244 includes an air blower arrangement 245 and a wet vacuum arrangement 246. The air blower arrangement 245 is configured to blow air on the chips. The wet vacuum arrangement 246 is configured to suck moisture away from the chips. Each of these arrangement may be widely varied. For example, the air blower arrangement 245 may include air injectors for injecting air at various pressures (high, medium, low) on the chips and the wet vacuum arrangement 246 may include vacuum ports for sucking air at various vacuum pressures. The injectors and ports may be stationary or they may be capable of moving so as to ensure that a substantial portion of the chip is dried. Furthermore, the injectors or ports may be positioned above or below the moving chips.

In the illustrated embodiment, the air blower arrangement 245 is configured to produce an air knife, i.e., a substantially planar air flow. The air knife may be vertical or it may be angled. In order to produce the air knife, the air blower arrangement 245 typically includes a pressure chamber and a first drying platform 247 having one or more slots capable of distributing a substantially uniform positive air flow. The volume of air produced by the air knife is configured to carry the moisture away (evaporative process). In some cases, the air is warmed to further enhance the drying effect. Similarly, the wet vacuum arrangement 246 typically includes a pressure chamber (not shown in FIG. 3) and a second drying platform 248 having one or more slots capable of distributing a substantially uniform negative air flow. The slots in both arrangements typically extend across their respective platforms. An example of these type of arrangements are shown in FIGS. 7A and 7B.

In one embodiment, the chips are slid through the dry assembly 244. For example, in the case of CSP's, the smooth side of the chip is slid along both of the drying platforms 247, 248. In most cases, the drying platforms are configured to provide planar surfaces that are level with one another. The second drying platform 248 is also configured to be level with the planar surface of the solution distribution plate 243 of the wash assembly.

Although not shown, the drying assembly may also include a heating platform where radiant heat is used to drive moisture away from the singulated chips.

The substrate processing system 200 also includes a second buffer station 260. The second buffer station 260 is generally arranged to provide a buffer area for removing the diced chips from the cleaning station 240 and for grouping the chips if desired. The buffer station may also be used to remove any remaining moisture on the product. In one embodiment, the second buffer station 260 serves as a space for getting the diced chips off of the cleaning station so that more chips may be cleaned. That is, by moving the separated dies to the second buffer station 260, a new set of singulated chips may be moved into the cleaning station 240 thereby reducing handling time. The second buffer station 260 generally includes a holding platform 262 that is arranged to abut the cleaning station 240, and more particularly the dry assembly 244. In one embodiment, the chips are slid from the surface of the cleaning station 240 to the holding platform 262. For example, in the case of CSP's, the smooth side of the chip is slid along the top surface of the cleaning station and the holding platform. In this embodiment, both the first drying platform 247 and the holding platform 262 are configured to provide planar surfaces that are level with one another, i.e., the planar surface are flush. By providing level surfaces, the chips may be easily slid from the cleaning station 240 to the second buffer station 260, i.e., without snags).

In one embodiment, the holding platform 262 is configured to retain the chips thereto during movement thereof. This is generally done to ensure that the chips do not walk away from their desired movement path, i.e., the holding platform 262 prevents chips from moving side to side and shingling relative to one another. In most cases, the holding platform 262 provides a retention force in a direction orthogonal to the movement force. For example, the retention force may be exerted in the Z direction while the movement force may be exerted in the X or Y directions. The movement force is generally configured to overcome the retention force so as to move the parts in the direction of the movement force. The retention force helps to maintain the part position while it is moved in the direction of the movement force. For example, the retention force may help to reduce part shingling in the direction of the movement force (e.g., Y direction) and side to side movements in a direction orthogonal to the direction of the movement force (e.g., X direction).

In the illustrated embodiment, the holding platform 262 uses a vacuum to provide the retention force, i.e., control the parts position. In this embodiment, the holding platform 262 includes a vacuum chamber 265 and a holding plate 264 capable of distributing a substantially uniform vacuum to the chips. The holding plate 264 generally includes a plurality of perforations that are substantially smaller than the size of the chips. Each of these perforations applies a retention or sucking force that pulls down on the chips when the chips are moved thereon. For example, in the case of CSP's, the holding plate is configured to provide a vacuum to the smooth side of the chips so as help keep them in position while they are moved across the surface of the holding plate. The retention force (vacuum) may be zero in some cases.

The holding plate may be widely varied. For example, the holding plate may be formed from perforated sheets, screens, fabrics, and the like. The size of the perforations is dependent on many factors, as for example, chip size and the vacuum force needed. By way of example, if the perforations are too small then the holding plate may not exert enough vacuum pull on the chips. In addition, if the perforations are too big, the holding platform may have loss of vacuum force and thus retention. Furthermore, as the chips are moved off of the holding plate, the vacuum may get weaker because more of the perforations tend to get exposed. If the vacuum pressure cannot be controlled through perforation size to an acceptable level, then the vacuum pressure itself may be controlled as the chips are moved across the surface. The vacuum control may detect how the vacuum is changing and adjust the vacuum accordingly. Alternatively or additionally, the retention force may be provided by a cover.

The substrate processing system 200 may also include a vision inspection station 300. The vision inspection station 300 is generally configured to inspect the chips. In most cases, the chips are fed row by row for vision inspection. The rows may be widely varied. For example, the vision inspection may be done in sets of four or eight chips at a time. They are momentarily separated in one direction for differentiation and acquisition by the vision system (e.g., some separation is needed so that the vision inspection can differentiate each of the chips which are side by side). In one embodiment, adjacent chips are separated such that consecutive chips are offset from one another. When acquisition of the parts is complete, the chips are moved out of the inspection area while at the same time removing the momentary separation, i.e., they are placed in a grouped array. The grouped array may be widely varied. The number and orientation of the chips in the grouped array is generally dependent on the size of the chips. By way of example, the chips may be grouped in arrays of 4 by 4, 4 by 8 or 8 by 8 when the vision inspection is done in sets of four and eight chips.

The vision inspection station 300 generally includes a holding platform 302 analogous to the one used in the second buffer station 260, i.e., the holding platform 302 is configured to retain the chips thereto during movement thereof. In one embodiment, the chips are slid along the holding platform 302. For example, in the case of CSP's, the smooth side of the chip is slid along the top surface of the holding platform 302.

The substrate processing system 200 may also include an orientation locator 320. The orientation locator 320 is generally arranged to rotate the chips so that the chips are placed in the proper orientation for uploading onto output trays. For example, the chips may be rotated so that the pin one orientation of the chips meets specified requirements. Pin one generally pertains to a point used on each of the chips for referencing their position, as for example, in the X and Y direction. In most cases, software determines the position of the pin ones from the start and throughout processing. The orientation locator generally includes a rotary table 324 capable of rotating the chips. The chips are generally rotated in the arrayed groups formed by the vision inspection station 300, i.e., the chips are positioned onto the rotary table in groups of 4 by 4, 4 by 8 or 8 by 8 (and the like). The angle of rotation may be widely varied. For example, the table 324 may be configured to rotate at angles of 0, 90, 180, 270 degrees in order to place the grouped array of chips in the proper uploading position. The position of the chips on the table may also be widely varied. For example, the chips may be centered or off centered on the table.

The rotary table 324 generally includes a holding platform 326 analogous to the one used in the second buffer station 260 and the vision inspection station 300, i.e., the holding platform 326 is configured to retain the chips thereto during movement thereof. In one embodiment, the chips are slid from the vision inspection system 300 to the holding platform 326. For example, in the case of CSP's, the smooth side of the chip is slid along holding platform 302 of the vision inspection station 300 and the holding platform 326 of the rotary table 324. In this embodiment, the holding platforms 302, 326 are configured to provide planar surfaces that are level with one another, i.e., the planar surface are flush. By providing level surfaces, the chips may be easily slid from the vision inspection station 300 to the orientation locator station 320, i.e., without snags.

The substrate processing system 200 may also include a third buffer station 340. The third buffer station 340 is generally arranged to provide a buffer area for removing the grouped array of chips from the orientation locator station 320 and for feeding into the next station. In one embodiment, the third buffer station 340 serves as a space for getting the chips off of the orientation locator 320 so that more chips may be rotated. That is, by moving the grouped array to the third buffer station 340, a new set of grouped arrays may be moved into the orientation locator 320 thereby reducing handling time. The third buffer station 340 generally includes a holding platform 342 analogous to the one used in previous stations, i.e., the holding platform 342 is configured to retain the chips thereto during movement thereof. In one embodiment, the chips are slid from the holding platform 326 of the orientation locator 320 to the holding platform 342 of the third buffer station 340. For example, in the case of CSP's, the smooth side of the chip is slid along both of the holding platforms 326 and 340. In this embodiment, the holding platforms 326 and 342 are configured to provide planar surfaces that are level with one another, i.e., the planar surface are flush. By providing level surfaces, the chips may be easily slid from the orientation locator 320 to the third buffer station 340, i.e., without snags.

Although not shown in great detail, the stations of the substrate processing system are generally positioned on a support plate 350. The support plate 350 is configured to support the stations. For example, the support plate 350 may support the buffer station 220, the cleaning station 240, the second buffer station 260, the vision inspection station 300, the orientation locator 320, the third buffer station and the like. As shown, a plurality of support structures 352, i.e., legs, are attached to the support plate 350. The support structures allow the substrate processing system to be situated on a floor. In the illustrated embodiment, three support structures are used for the purposes of leveling the system (e.g., three points define a plane). The support plate 350 may also provide the duct work that routes the various fluids to the stations. For example, the support plate 350 may include channels for distributing vacuum to the holding platforms, for distributing pressurized air and vacuum to the dry assembly, and for distributing a cleaning solution to the wash assembly. The channels themselves may be connected to inlets such as a wet vacuum inlet 354, a pressurized air inlet 356, and one or more vacuum inlets 358.

The substrate processing system 200 also includes a plurality of transfer units for conveying the chips from the chuck assembly 212 to the output trays 372 and 374. The conveying range of the transfer units may overlap each other in order to further reduce the handling time of the system 200. The transfer units are generally configured to move a group of chips from one area to another within the processing system 200. The transfer units may also be arranged to compact the chips into groups, or they may be arranged to separate a group, as for example, into rows. The driving mechanisms for the transfer units may be widely varied. For example, the transfer units may be motor driven, i.e., they me be driven by a pneumatic motor, servo motor or the like. Motor drives are generally well known in the art and for the sake of brevity will not be discussed in greater detail herein.

Referring, to FIG. 3B, the transfer units of the substrate processing system 200 will be described in greater detail. In one embodiment, the separated chips are removed from the chuck assembly 212 by a first transfer unit 230. The transfer unit 230 is generally configured to move the diced chips off of the chuck assembly 212 and onto the buffer platform 222. For example, the chips may be pushed or pulled. When moved, the chips slide across the surfaces of the chuck assembly 212 and buffer platform 222. For example, the chips may be slid along the rubberized surface of the vacuum chuck 214 when moving the chips off of the vacuum chuck 214. The transfer unit 230 generally includes a transfer arm 231 that engages the chips for movement thereof, i.e., the transfer arm 231 engages the chips and pushes (pulls) the chips off of the chuck 214 and onto the buffer platform 222. In most cases, the chips are moved together (i.e., gang processing). In one implementation, the transfer arm 231 comes in from above the chips, engages the last row of singulated chips, and thereafter slides the chips along the surfaces of the chuck assembly 212 and buffer station 220. During the sliding, each consecutive row of chips generally moves to abutment with the next consecutive row until the chips are grouped together in the direction of the movement (i.e., compacting). The transfer arm 231 generally includes a lip 232 for collecting and compacting the chips and a cover plate 234 for preventing the chips from buckling and jumping over adjacent chips (e.g., shingling effect) during chip movement.

The transfer arm may be widely varied. For example, the transfer arm may be adapted differently for different types of substrates and for a different number of substrates. As should be appreciated, each substrate may include one or more groups of chips, and each group of chips may include a different chip array (4 by 4, 10 by 10, and the like). Furthermore, multiple substrate processing (dual chuck) may require a different configuration than single substrate processing (single chuck). In the illustrated embodiment, the transfer arm 231 includes a plurality of pockets 233. Each of the pockets 233 is configured to receive a group of diced and arrayed chips. As shown, each of the pockets defines a lip 232 that is configured to collect and compact its corresponding group of arrayed chips, i.e., the separated chips are ganged together via the lip 232 pushing/pulling against them. The transfer arm 231 also includes a plurality of cover plates or screens 234, each of which covers an individual pocket 233. Not all of the cover plates 234 are shown in FIG. 3B in order to show some of the lips 232.

The cover plates are generally configured with openings that allow washing and drying, vacuuming and the like to occur therethrough so that the integrated chips may be cleaned and dried from the top and bottom while still being retained. The openings are generally arranged to be smaller than the chips so as to contain the chips inside the pocket. The cover may be widely varied. For example, the cover plates may be formed from grids or bars, perforated sheets, woven mesh or other similar structures, which form a plurality of openings therethrough. Further, the cover may be formed from any suitable material such as metals (e.g., stainless steel), plastics and the like. In one embodiment, the cover is formed from a mesh screen so as to allow air and fluids to flow therethrough during washing and drying.

It should be noted that this particular configuration is not a limitation, and that the configuration may vary according to the specific needs of each device. For example, the transfer arm may include only one lip (one pocket) or one cover plate that covers the entire transfer arm (rather than one particular pocket).

The transfer unit 230 may also be arranged to move the singulated chips through the cleaning station 240. For example, once the chips are positioned on the buffer platform 222, thus allowing new set of substrates to be placed on the chuck assembly 212, the singulated chips may be moved from the buffer platform 222 to the cleaning station 240. In most cases, the transfer arm 231 moves through cleaning station 240 at a slow and uniform speed. During washing, the chips are slid through a layer of cleaning solution. During drying, the chips are slid through a vacuum area and an air knife. The cover 234 of the transfer arm 230 generally prevents the chips from being washed or blown away during movement through the wash and dry assemblies 242, 244.

Once cleaned, a second transfer unit 250 may be arranged to further move the plurality of chips. The second transfer unit 250 is configured to take over for the first transfer unit 230 thus allowing the first transfer unit 230 to go and get more chips from the chuck assembly 212. The transfer area between transfer units may be almost anywhere, however, it generally exists somewhere after the drying area. For example, the transfer area may be located on the second buffer station 260 next to the drying assembly 244. The second transfer unit 250 may also be arranged to further compact the chips. For example, it may be arranged to compact the groups of arrayed chips together in one or more larger groups.

The second transfer unit 251 generally includes a second transfer arm 251 and a third transfer arm 253, each of which engages the chips for movement thereof, i.e., the transfer arms engage the chips and push (pull) the chips across the buffer station 260. In one implementation, the second transfer arm 251 engages the last group of arrayed chips, and thereafter slides the groups along the surfaces of the buffer station 260 in a first direction. During the sliding, each consecutive group of arrayed chips generally moves to abutment with the next consecutive group of arrayed chips until the groups are grouped together in the direction of the movement (e.g., become compacted). In another implementation, the third transfer arm 253 engages the sides of the group of arrayed chips, and thereafter slides the groups along the surfaces of the buffer station 260 in a second direction. During the sliding, each consecutive row inside the group of arrayed chips moves to abutment with the next consecutive row of the group of arrayed chips until the rows are grouped together in the direction of the movement (e.g., become compacted).

Once the first transfer arm 231 is out of the way, the second transfer arm 251 engages the last chips in each row of chips and pushes them across the second buffer station 260. Similar to the first transfer arm 231, the second transfer arm 251 includes a lip 252 so as to push the chips through the second buffer station 260. Unlike the first transfer arm 231, however, the second transfer arm 251 does not include a cover. This is generally the case because of the holding power of the holding platform 262 of the second buffer station 260. That is, the chips are substantially retained thus preventing shingling and side to side movements (a cover is generally not needed). By having no cover, the chips may be viewed as they are conveyed across the buffer station 260. As shown, the second transfer arm 251 moves in a similar direction to the direction of the first transfer arm 231. It generally moves the chips until the first chip in each row of chips abuts a reference surface 257 at the end of the buffer station 260. It should be noted that coverless transfer arms are not a limitation and that in some cases a cover may be used.

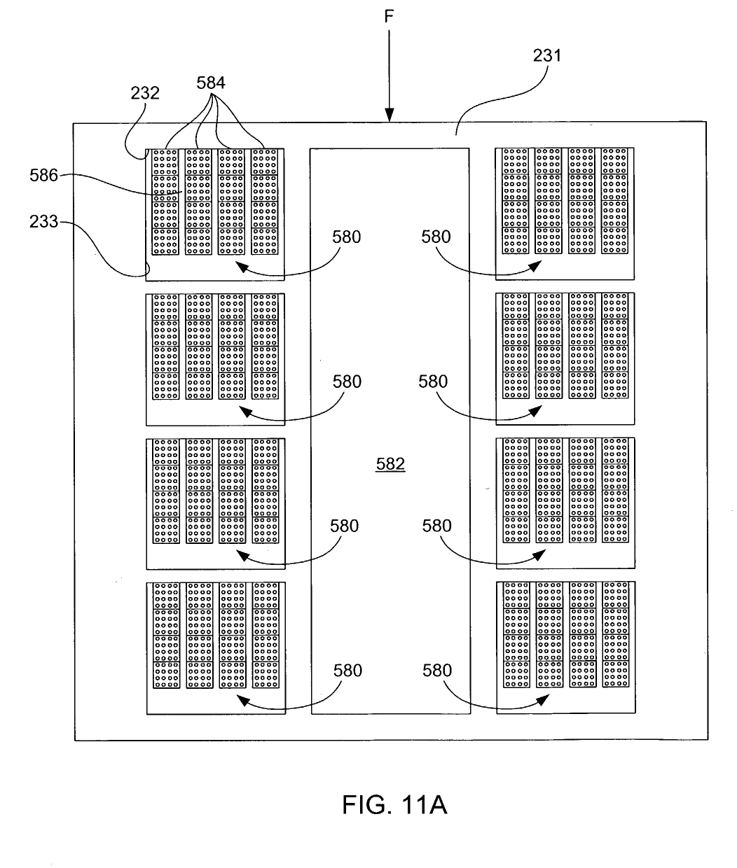

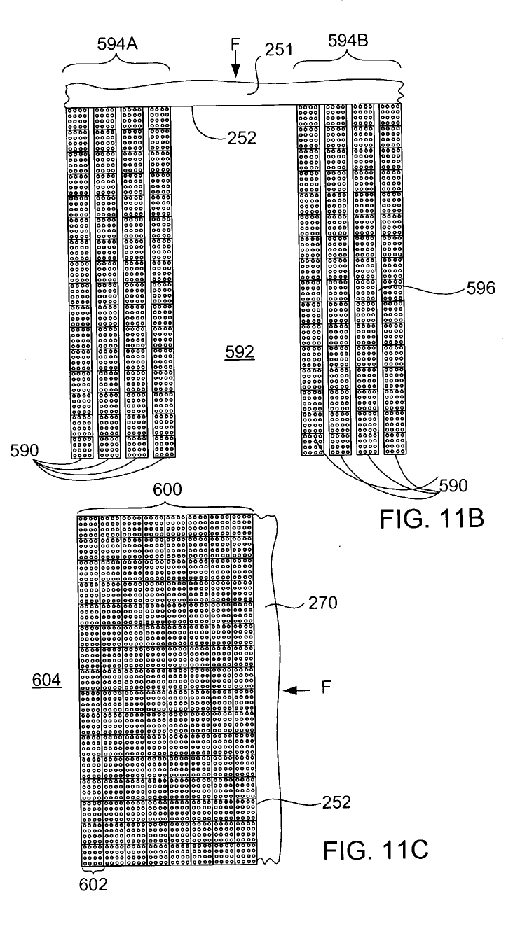

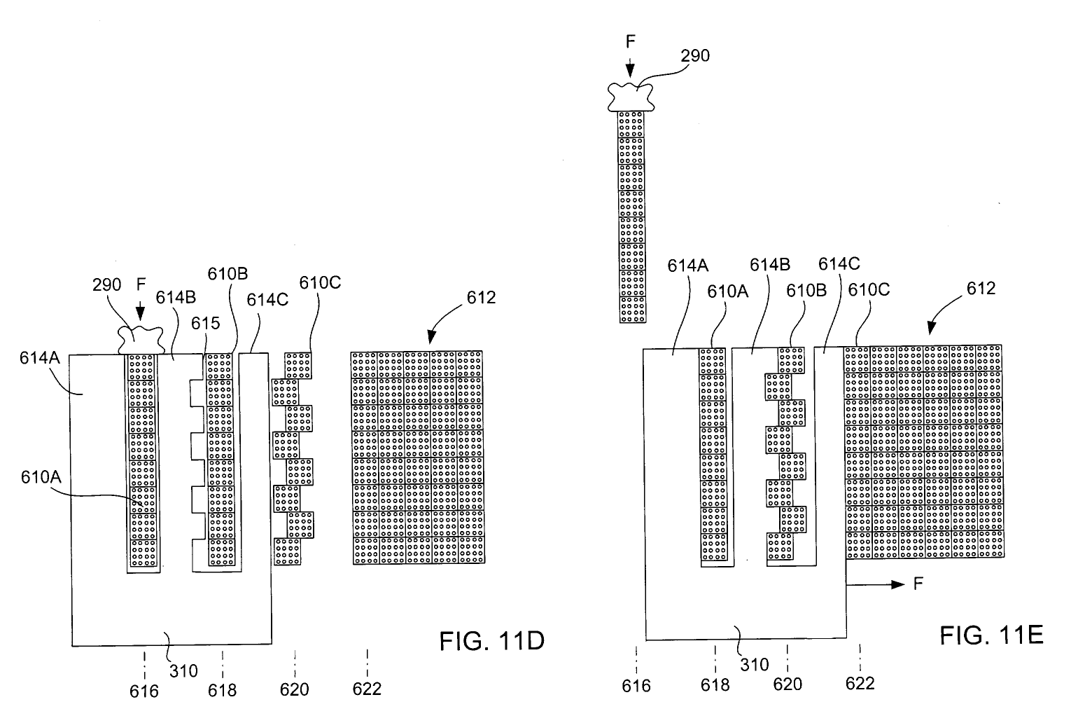

During movement by the second transfer arm 251 or once the chips are positioned along the reference surface 257, the third transfer arm 253 may be arranged to further move the plurality of chips. The third transfer arm 253 is generally configured to place at least a portion of the chips into a group. That is, it pushes at least a portion of each of the rows into a corresponding portion of the next row until a group has been formed (see FIG. 11C). That is, the third transfer arm 253 engages a first row of chips and pushes them into a second row of chips and so on until there are no spaces therebetween. As should be appreciated, the third transfer arm 253 generally moves in a direction orthogonal to the movement of the first and second transfer arms 231, 251. For example, if the first and second transfer arms 231, 251 move in the X direction, then the third transfer arm 253 moves in the Y direction. The third transfer arm 253 is analogous to the second transfer arm 250 in that it includes a lip 252 and no cover. The third transfer arm 253 may also be configured to separate the grouped array of chips into rows that can be moved by the next set of transfer units. The third transfer arm 253 is sometimes referred to as a row feeder.

The system may also include a row lifter 280 and a row pusher 290 (shown in FIG. 3A). The row lifter 280 is arranged to lift a row of chips from a first position to a second position. The row of chips are generally positioned on the row lifter 280 via the third transfer arm (row separator) 253 by pushing on the grouped array of chips one row at a time. In one embodiment, the first position corresponds to the position of the holding platform 262 of the second buffer station 260, i.e., the lifter and the holding platform are level when the lifter is in the first position. Once the row of chips are lifted to the second position, the row pusher 290 is configured to push the row of chips into the area of the vision inspection system 300. In one embodiment, the second position corresponds to the position of the holding platform 302 of the vision inspection system 300, i.e., the lifter 280 and the holding platform 302 are level when the lifter is in the second position. Therefore, the row pusher 290 moves the chips across and onto the holding platform 302. In the illustrated embodiment, the row pusher 290 moves in a direction orthogonal to the direction of the third transfer arm 253.

In one example, the sequence may include: 1) pushing a first row onto the row lifter 280 via the row separator 253, 2) lifting the first row from the first position to the second position via the row lifter 280, 3) pushing a portion of the first row onto the holding platform 302 of the vision inspection system 300 via the row pusher 290. The row separator, row lifter and row pusher generally cooperate to continuously feed the vision inspection system 300 a row of parts at a time.

The system may also include a row indexer 310 that cooperates with the row pusher 290 to move one or more rows. The row indexer 310 includes a plurality of fingers, which are configured to push subsequent rows that were pushed onto the platform 302 via the row pusher 290 across the holding platform 302 of the vision inspection system 300. The fingers generally operate by translating in a forward direction, lifting, translating in a reverse direction, and lowering (e.g., sometimes referred to as a walking beam). In the illustrated embodiment, the fingers translate in a direction orthogonal to the direction of the row pusher 290. Each of the fingers includes a lip for engaging a row of chips. The row indexer 310 does not include a cover. Each of the fingers represents a new row position. The number of row positions and fingers may be widely varied. In the illustrated embodiment, the row indexer 310 includes three fingers and thus four row positions. The row indexer 310 is configured to continuously operate until a plurality of rows are grouped in an array on the rotary table 324. An example of a row indexer is shown in greater detail in FIG. 11D.

A typical sequence of the row indexer 310 may include: 1) receiving a first row of chips from the row pusher in the first position, 2) pushing the first row of chips into the second position via the first finger, 3) moving back to receive a second row of chips while leaving the first row in the second position, 4) receiving a second row of chips from the row pusher in the first position, 5) pushing the second row of chips into the second position via the first finger and the first row of chips to the third position via the second finger, 6) moving back to receive a third row of chips while leaving the first row and second row in their respective positions, 7) receiving a third row of chips from the row pusher in the first position, 8) pushing the third row of chips into the second position via the first finger, the second row of chips to the third position via the second finger and the first row of chips to the fourth position via the third finger, 9) moving back to receive a fourth row of chips while leaving the first, second and third rows in their respective positions, 10) receiving a fourth row of chips from the row pusher in the first position, 11) pushing the fourth row of chips into the second position via the first finger, the third row of chips to the third position via the second finger, the second row of chips to the fourth position via the third finger and abutting the first row of chips an array being formed on the way to the rotary table, 12) moving back to receive a fifth row of chips while leaving the first, second, third and fourth rows in their respective positions, 13) receiving a fifth row of chips from the row pusher in the first position, 14) pushing the fifth row of chips into the second position via the first finger, the fourth row of chips to the third position via the second finger, the third row of chips to the fourth position via the third finger, abutting the second and first row of chips on its way to the rotary table. This generally continues through more iterations until a grouped array is formed on the rotary table. An example of a row indexer in operation is shown in greater detail in FIG. 11D.

Although not shown, the system may include a fourth transfer arm for moving the grouped array from the rotary table 324 to the third buffer station 340.

The substrate processing system 200 may also include an inverter 360. The inverter 360 is arranged to invert the chips so that the balls of the ball grid arrays are facing down rather than up. That is, as a row is fed into the inverter 360, the parts are balls up and as the rows are output by the inverter 360 they are balls down. This inversion is generally done so that the chips may be easily picked up by a pick and place assembly 370, i.e., inversion allows the smooth surface side of the chips to be picked up by suction cups of the pick and place assembly 370. For example, the inverter 360 may rotate the chips to present the parts to the pick heads balls down for easy pick up. In one implementation, there are two inverters 360 operating independently to feed two pick heads. Once picked up, the chips are ready to be placed (e.g., loaded) in a tray by the pick and place head. The chips may be sorted, at this point, to either an offload tray 372 or a reject tray 374. By way of example, the trays may be JEDEC trays. Any suitable pick and place assembly may be used. By way of example, a pickhead assembly that may be used in the substrate processing system is described in greater detail in a co-pending patent application entitled, “HIGH SPEED PICKHEAD”; (Attorney Docket No.: ICONP005P), filed on even date and incorporated herein by reference.

It should be noted that the previously described transfer units are not a limitation and that they may be embodied in many forms. Furthermore, the system may include other types of transfer units. For example, the system may include a transfer unit for moving the chips from the orientation locator to the third buffer station. This transfer unit may be similar to the second transfer unit, i.e., it may include two transfer arms, each of which moves the chips in orthogonal directions (e.g., X and Y). Additionally, the system may include a lifter that lifts the chips to the inverter (e.g., inverter loader). This type of lifter is generally located next to the third buffer station so as to receive one or more chips therefrom.

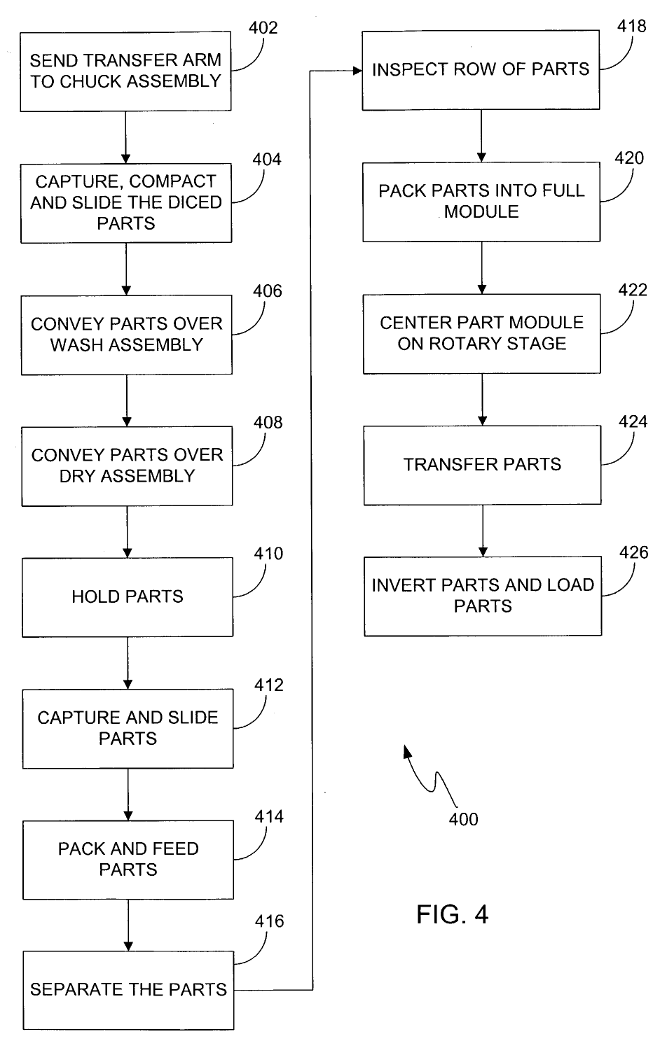

FIG. 4 is a flow diagram illustrating a processing sequence 400 of the substrate processing system 200, in accordance with one embodiment of the present invention. The processing sequence generally begins at block 402 where the system sends the first transfer arm 231 to the chuck assembly when the singulation cycle is completed and the chuck assembly 212 is its initial position. Following block 402, the process sequence proceeds to block 404 where the first transfer arm 231 captures, compacts, and slides the diced chip arrays to the cleaning station 240. Following block 404, the process sequence proceeds to block 406 where the parts are slowly conveyed over the wash assembly 242. In the wash assembly, a low flow fluid loosens and floats away any sawing slurry residue that remains trapped under the parts.

Following block 406, the process sequence proceeds to block 408 where the parts are slowly conveyed over the dry assembly 244. In the dry assembly, the wet vacuum(s) suck most of the water from the chip array and a high flow of heated air is forced over the moving part array to further remove moisture and dry the parts. Following block 408, the process sequence proceeds to block 410 where the parts are held stationary in the dry zone (last portion of dry assembly or first part of second buffer station) until the previous array of parts are cleared from the second buffer station 260. During this time, a flow of warm air is provided to assist complete drying of the diced part array. Following block 410, the process sequence proceeds to block 412 where when the second buffer station 260 is cleared, the first transfer arm 231 returns to the chuck assembly 212 and the second transfer arm 251 captures the part array at the dry zone and moves the parts to the second buffer station 260. Following block 412, the process sequence proceeds to block 414 where the second transfer arm 251 completely packs the parts edge to edge in the Y direction and the third transfer arm 253 completely packs the parts side to side in the X direction. The third transfer arm may also feed the row lifter 280 one row at a time.

Following block 414, the process sequence proceeds to block 416 where the rows are lifted and separated from the array before being fed into the vision inspection station 300. Following block 416, the process sequence proceeds to block 418 where the row pusher 290 separates a module row into four or eight and the row indexer 310, in walking beam fashion, feeds and simultaneously staggers a separated module row to the vision inspection position 300. Following block 418, the process sequence proceeds to block 420 where the row indexer 310 repacks the staggered row and packs a full module for presentation to the rotate stage 320. A full module generally consists of 4 by 4, 4 by 8 or 8 by 8 array of parts created by the final edge of the row indexer 310. Following block 420, the process sequence proceeds to block 422 where the full module is positioned on the rotate stage 320 (any location thereon) and then rotated in 90 degree increments to achieve correct pin one orientation. Following block 422, the process sequence proceeds to block 424 where an inverter transfer arm (not shown) transports the new module to the inverter 360 when the inverter 360 is sufficiently clear. Following block 424, the process sequence proceeds to block 426 where the module is fed one module row at a time into the inverter 360 where the parts are removed by the pick heads 370 for loading into trays 372 and 374.

It should be noted that the sequence described in FIG. 4 is not a limitation and that other sequences are possible. For example, the sequence may be practiced without some or all of these blocks or it may be practiced with additional blocks (as best appreciated by those skilled in the art). By way of example, if the system 200 only includes the chuck assembly 212 and the cleaning station 240 then blocks 410 through 426 may be eliminated. In addition, if the system only includes the cleaning station 240 and the second buffer station 260 then the blocks 402, 404 and 416 through 426 may be eliminated. Moreover, if the system includes a testing station or another type of processing station then the sequence may include additional blocks. These additional blocks may be placed anywhere within the sequence. The invention may also be practiced in a different order. For example, the order of the stations described in FIG. 3 may vary according to the specific needs of each system and thus the sequence of the blocks may be changed.

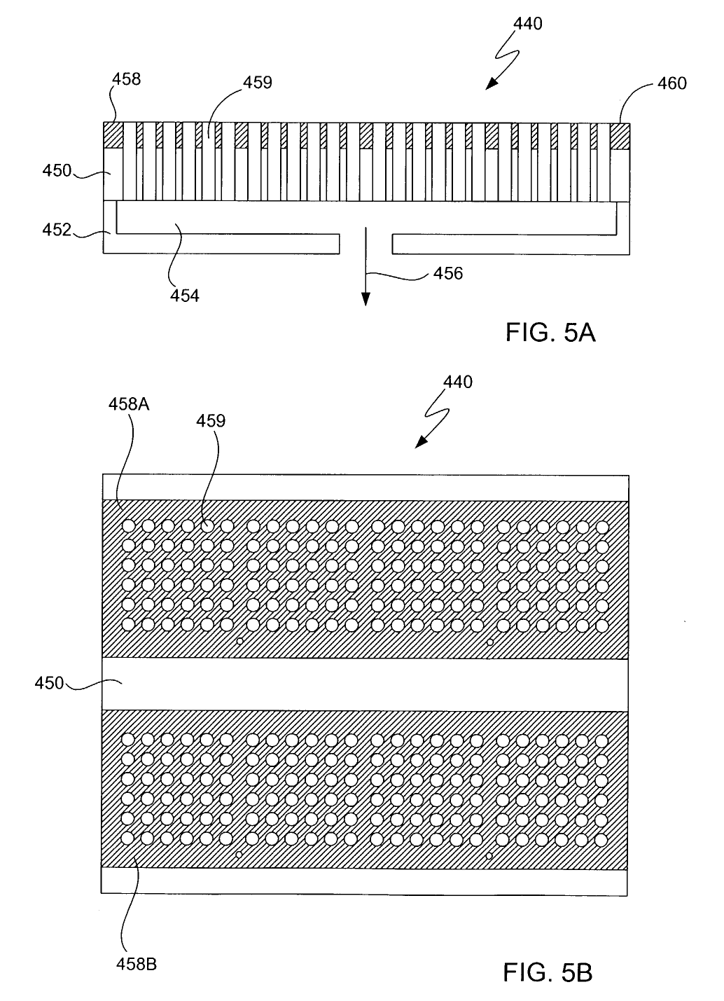

FIGS. 5A and 5B are top and side views, respectively, of a dual chuck assembly 440, in accordance with one embodiment of the present invention. By way of example, the dual chuck assembly 440 may generally correspond to the chuck assembly 212 shown in FIG. 3. The dual chuck assembly 440 includes a first plate 450 and a second plate 452 that combine to form a vacuum region 454. By way of example, the first and second plates 450 and 452 may be formed from aluminum and may be coupled to one another through any suitable attachment means (e.g., bolts, screws, glues, adhesives, welds and the like). The vacuum region 454 is fluidly coupled to a vacuum source that provides a vacuum 456 to the chuck assembly 440. In most cases, the vacuum region 454 is coupled to the vacuum source with a coupling (not shown).

The chuck assembly 440 also includes a pair of substrate contact surfaces 458A and 458B that are attached to the first plate 450. The substrate contact surfaces may be attached to the first plate 450 in any suitable manner as for example by using an adhesive. As shown, the chuck assembly 440 also includes a plurality of openings 459 that extend through the first plate 450 and the substrate contact surfaces 458 from the vacuum region 454 to the top 460 of the substrate contact surfaces 458. Each of the openings 459 corresponds to an individually separated chip (as for example, one of the chips 2 shown in FIGS. 1A and 1B). The openings 459 and the substrate contact surfaces 458 cooperate to hold a pair of substrates, as well as the singulated chips, on the surface 460 when the vacuum 456 is supplied. The substrates may be moved thereon when the vacuum 456 is turned off.

The chuck assembly may be widely varied. For example, the arrangement of openings 459 is generally dependent on the substrates to be processed and the number of chips disposed thereon. In addition, the substrate contact surface 458 may be formed of any suitable material that substantially seals the interface between the bottom surface of the substrate and the openings 459 when a sucking force is being applied by the vacuum region 454. The substrate contact surface 458 may also include properties such as slip resistance, heat resistance, abrasion resistance, wear resistance, chemical resistance and the like. The substrate contact surface 458 may also exhibit properties such as charge dissipation or ESD ground resistance. The substrate contact surface 458 may also have properties that provide a low coefficient of friction to permit the chips to slide easily. Some of the materials that may exhibit one or more of these properties include conductive polyethylene, dissipative homogeneous vinyl, dissipative anti fatigue conductive smooth rubber, and conductive anti fatigue dissipative dual rubber. The substrate contact surface 458 may be formed from rolls, mats, tiles, and the like. The substrate contact surface 458 may also be formed from one or more layers. By way of example, the substrate contact surface 458 may be formed from anyone of the materials produced by Static Specialists Co., Inc of Bohemia N.Y. In one particular embodiment, the substrate contact surface 458 is formed a rubber material that offers resistance to oil, grease and most common solvents used in dicing, and a coefficient of friction that provides some slip resistance while still allowing a sliding action thereon.

Some aspects of the chuck assembly 440 may be found in U.S. Pat. Nos. 6,187,654 and 6,165,232, each of which is herein incorporated by reference.

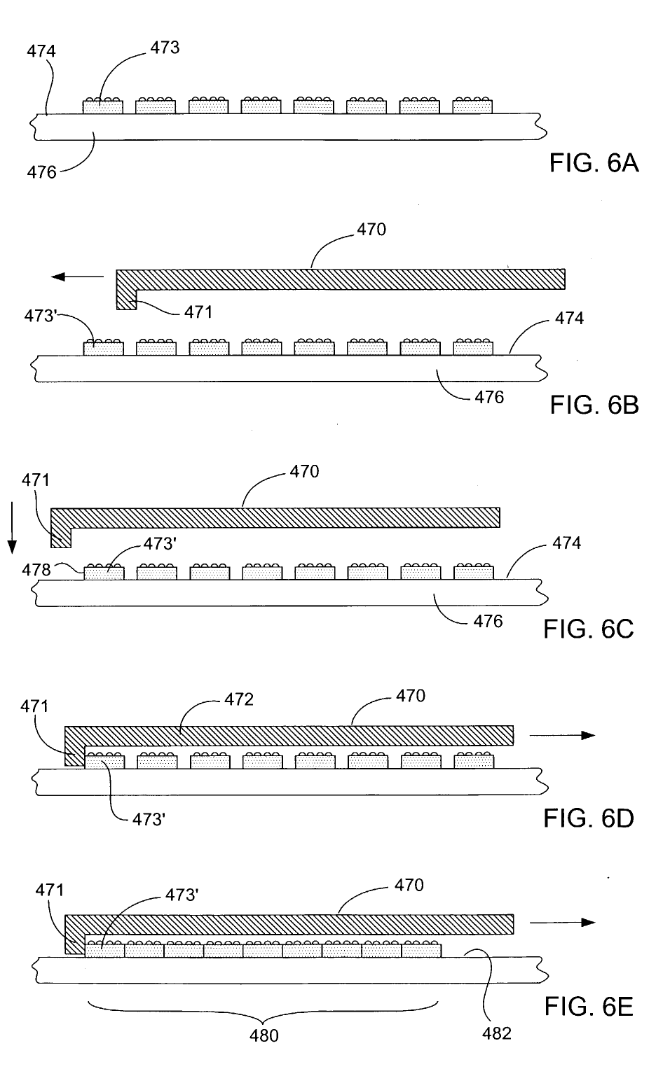

FIGS. 6A-6E are simplified diagrams showing the movements of a transfer arm 470, in accordance with one embodiment of the present invention. By way of example, the transfer arm 470 may correspond to a portion of the first transfer arm (e.g., pocket) shown in FIG. 3. The transfer arm 470 has been simplified in FIG. 6. As shown in FIG. 6, the transfer arm 470 includes a lip 471 for engaging the parts horizontally, and a cover 472 for preventing the parts from moving vertically upwards when the parts are moved horizontally along a surface, i.e., the cover 472 stops the parts from skipping off the surface (friction). The transfer arm 470 via the cover 472 prevents the shingling of parts.

As shown in the sequence of FIGS. 6A-6E, the transfer arm 470 moves both vertically and horizontally to engage and move the separated parts from the chuck assembly. For example, FIG. 6A illustrates a plurality of separated parts 473 positioned on a surface 474 of a chuck assembly 476. By way of example, the plurality of separated parts may generally correspond to the separated parts shown in FIG. 1B. FIG. 6B illustrates the transfer arm 470 moving horizontally past the last separated parts 473′. FIG. 6C illustrates the transfer arm 470 moving vertically down to place the transfer arm 470 in a position for engaging an edge 478 of the separated parts 473′. FIG. 6D illustrates the transfer arm 470 moving horizontally to engage the last separated parts 473′. FIG. 6E illustrates the transfer arm 470 moving a group of parts after the parts 473 have been forced together into a group 480. Forcing into a group is sometimes called compacting the product (i.e., moving the product closer together to remove the kerf space remaining from the sawing operation). It should be noted that there are still spaces in the opposite direction and therefore the separated parts are in groups of rows. Furthermore, in FIG. 6E, the surface 482 in which the parts slide may represent the surface 474 of the chuck assembly or some other surface as for example, a surface provided by a buffer or cleaning station.

FIGS. 7A and 7B are side and top views respectively, of a cleaning station 490, in accordance with one embodiment of the present invention. By way of example, the cleaning station 490 may generally correspond the cleaning station 240 shown in FIG. 3. The cleaning station 490 includes a wash assembly 492 and a drying assembly 494. The wash assembly 492 includes a housing 496 and a perforated or porous surface plate 498. The housing 496 and perforated surface plate 498 generally cooperate to provide a fluid chamber 500 where a cleaning solution 502 is stored before distribution. The fluid chamber 500 is typically coupled to a cleaning solution source (not shown) that supplies the cleaning solution 502. In one embodiment, the cleaning solution 502 is deionized water. The perforated surface plate 498 is configured to have a plurality of small openings 504 for providing the cleaning solution 502 therethrough. The openings 504 are preferably small as compared to the surface area of the smooth side of the separated chips. By way of example, the openings 504 may have a diameter between about 150 to about 250 microns. Although a diameter is mentioned hereto, it should be noted that this is not a limitation. That is, the size and shape may vary according to the specific needs of each station. For example, the size may be smaller or larger than the numbers given and the shape may be shapes other than circular such as oval, rectangular and the like.

When the cleaning solution 502 is flowed into the fluid chamber 500, the cleaning solution 502 is forced through the openings 504 thus causing the cleaning solution 502 to bubble above the top surface 506 of the perforated surface plate 498. In one embodiment, the cleaning solution 502 is allowed to flow above the separated parts when they pass over the perforated surface plate 498 (i.e., the parts are submerged). Using this configuration, the cleaning solution 502 may pass over the surfaces of the parts so as to remove particles and debris. Once exiting the holes 504, the cleaning solution 502 is allowed to flow towards the left, right, back and front sides of the perforated surface plate. The cleaning solution that is allowed to flow to the back and sides may be collected by a gutter, as for example, the gutter 243 shown in FIG. 3B. In the front, the cleaning solution is prevented from flowing by the dry assembly. The flow of cleaning solution, and thus the volume, is preferably held constant as the parts are moved therethrough from the back to the front of the perforated surface plate.

After the separated parts exit the cleaning solution puddle 508, they pass into the dry assembly 494. The dry assembly 494 includes a housing 520, which defines a negative pressurized region 522 and which includes one or more slots 524. The pressurized region 522 is fluidly coupled to a negative pressure source. The slots 524 generally extend from the first side 513 to a second side 515 of the housing 520. The slots 524 are arranged to form a wet vacuum to vacuum (suck) moisture away from the separated parts. The number of slots may be widely varied. The number of slots is typically dependent on cost benefit analysis, i.e., increasing the number of slots increases the cost, but it may or may not increase the drying effect. In the illustrated embodiment, three slots 524 are used. The angle of the slots may also be widely varied. For example, the slots may be slanted or they may be vertical (as shown). The spacing (the distance between slots) and slot width may also be widely varied. The spacing of the slots as well as the slot width generally depends on the size of the chip. By way of example, a slot width between about 500-700 microns may be used. In addition, a spacing of between about 3 mm to about 5 mm may be used.

The dry assembly 494 also includes a housing 510, which defines a positive pressurized region 512 and which includes one or more slots 514. The pressurized region 512 is fluidly coupled to an air pressure source (e.g. an air compressor). The slots generally extend from a first side 513 to a second side 515 of the housing 510. The slots 514 are arranged to form one or more air knives 516. By air knife it is meant a substantially planar region of pressurized air, i.e., a wall of air. The one or more air knives 516 are configured to blow air on the separated parts as they pass therethrough so as to remove moisture from the separated parts, similar to an air drying system of a car wash. In one embodiment, the air of the air knives is heated to further enhance the drying capabilities.

The number of slots may be widely varied. The number of slots is typically dependent on cost benefit analysis, i.e., increasing the number of slots increases the cost, but it may or may not increase the drying effect. In the illustrated embodiment, three slots 514 are used to produce three air knifes 516, respectively. The angle of the slots may also be widely varied. For example, the slots may be slanted or they may be vertical (as shown). The spacing (the distance between slots) and slot width may also be widely varied. The spacing of the slots as well as the slot width generally depends on the size of the part (e.g., chip). By way of example, when processing chips, a slot width between about 600 to about 1000 microns may be used. In addition, a spacing of about 2 mm and greater may be used. The pressure of the air may also be widely varied. For example, a pressure of about 1 to about 100 psi may be used. It should be noted, that these numbers are not a limitation and that they may vary according to the specific needs of each system. For example, it may be desirable to have a high flow/low pressure or low flow/high pressure or something therebetween. In one particular embodiment, the pressure is configured to be between about 1 to about 5 psi (this allows for low air consumption in the system).

Although FIG. 7 shows the air blowing region positioned after the vacuum region, it should be noted that this is not a limitation and that they may be swapped.

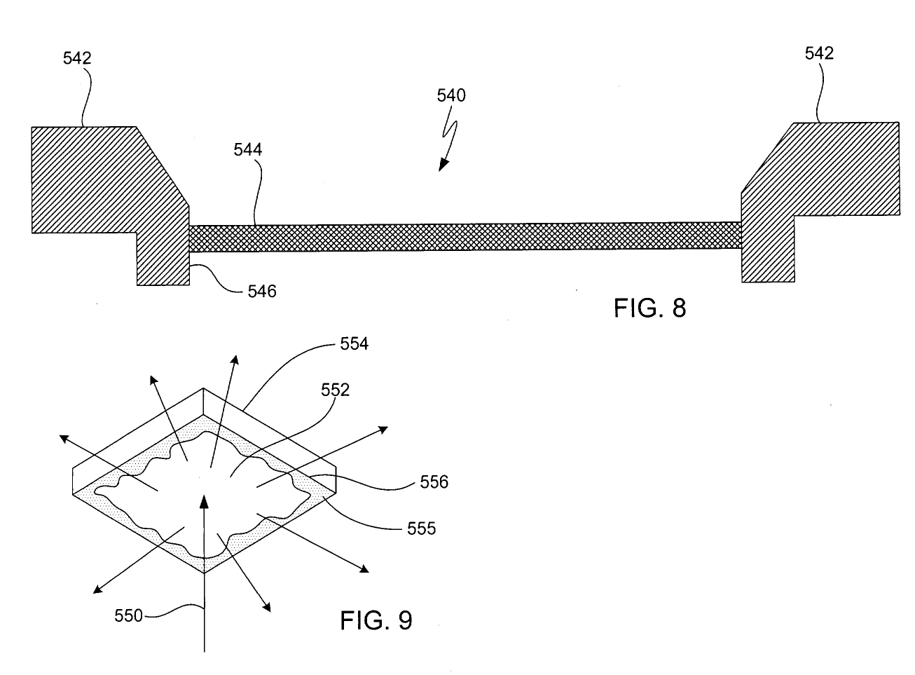

FIG. 8 is a side elevation view of a transfer arm 540 for moving the chips across a cleaning station, in accordance with one embodiment of the present invention. By way of example, the transfer arm 540 may generally correspond to a portion of the first transfer arm shown in FIG. 3, as for example a single pocket 233. The transfer arm 540 includes a frame 542 that surrounds a screen 544. The frame provides a structure for the transfer arm and a lip 546 for moving the parts along a surface. The screen 544 is attached to the frame 540. The screen 544 is configured to act as a cover to prevent the parts from moving away from the desired position. The screen also prevents the parts from being shot away from the surface when the cleaning solution pushes on the parts or when the air knife pushes on chips, i.e., the chips abut the bottom of the screen. As should be appreciated, the screen includes a plurality of openings that allow the cleaning solution and air knives to pass therethrough. The position of the screen is generally positioned to limit the amount of vertical movement of the parts. The position is arranged to provide a gap between the perforated plate and the screen when the parts are forced against the screen.

FIG. 9 shows a pressurized fluid 550 attacking a smooth side 552 of a single chip 554 and thus illustrates the force on the bottom of the part. As shown by the arrows, the pressurized fluid 550 hits and moves across the smooth side 552 of the chip 554 thereby removing debris on the smooth side 552 of the chip 554. In particular, the pressurized fluid 550 may remove debris 555 stuck to the edges 556 of the chip 554. The debris at the edges 556 is generally created during singulation.

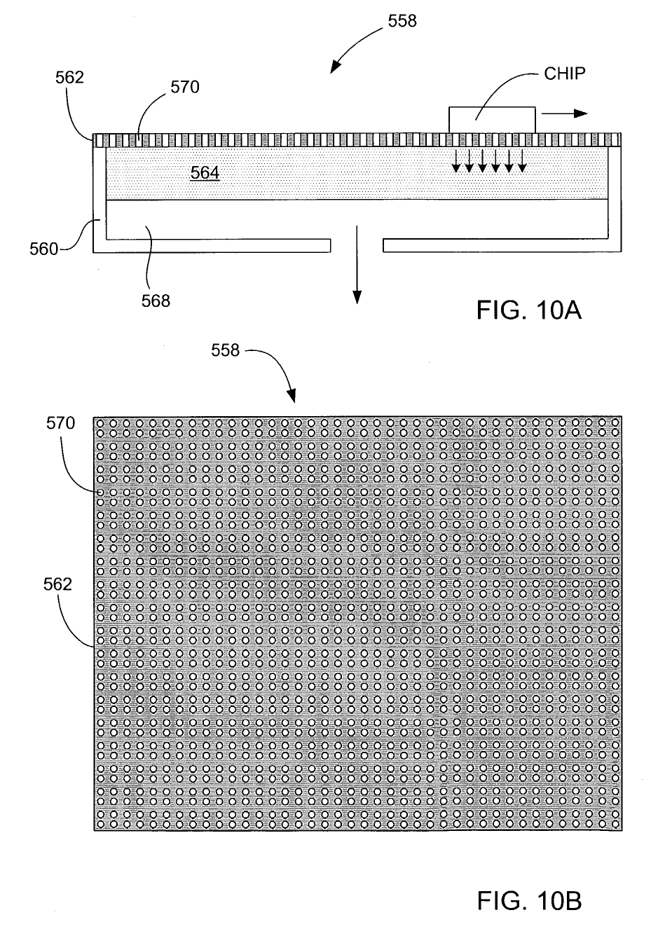

FIGS. 10A and 10B are side and top views, respectively of a holding platform 558, in accordance with one embodiment of the present invention. By way of example, the holding platform 558 may generally correspond to any one of the holding platforms 262, 302, 326, 342 shown in FIG. 3. The holding platform 558 generally provides a retention or suction force that is configured substantially hold one or more parts while they are conveyed through a system. The force may be used to keep the parts in a particular movement path (prevent parts from straying), in a particular position relative to other parts (prevent shingling), and/or the like. The retention or suction force may be widely varied. In most cases, the retention or suction force is normal to the direction of conveyance. As such, the flat surface of the parts may be forced towards the holding platform 558. Although the parts are forced towards the holding platform 558, the force is generally configured to allow parts to move across the holding platform 558. That is, while the force may provide a certain amount of holding force to keep the parts in a particular path or position, it is generally not strong enough to prevent part movement, as for example, by a transfer arm pushing them across the holding platform 558.

The holding platform 558 generally includes a housing 560, a perforated surface plate 562, and an air sponge 564. The housing 560 and perforated surface plate 562 generally cooperate to provide a vacuum region 568 within which the air sponge 564 is located. Although not shown, the vacuum region 568 is typically coupled to a vacuum source (not shown) for generating a vacuum therein. The perforated surface plate 562 is configured to allow a downward suction force therethrough, and to provide a smooth low friction sliding surface, both of which are intended to secure the location of parts and to assist in the prevention of shingling (parts climbing on top of each other). As shown, the perforated surface plate 562 is configured to have a plurality of small openings 570 for providing a vacuum therethrough. The vacuum force distributed by the openings is configured to control the position of the parts on the perforated surface while they are moved thereon. The perforated surface plate 562 may be analogous to an air hockey table, except that instead of supplying air pressure as in an air hockey table, the perforated surface plate supplies a vacuum to retain the parts in a desired position relative to one another.

To elaborate, the openings 570 are preferably small as compared to the surface area of the smooth side of the separated part. For example, for small parts such as integrated circuits, openings having a diameter of about 1 to about 300 microns may be used. In one particular embodiment, the diameter of the openings are between about 1 micron and 20 microns. In another embodiment, the diameter of the openings is between about 150 and 250 microns. It should be noted, however, that this is not a limitation and that the size of the openings may vary according to the specific needs of each device. In most cases, the perforated surface plate is configured to provide a sufficient obstruction to flow (sufficiently low permeability) while requiring a suitably minimal flow to achieve the desired retention force. Furthermore, although the term diameter is used, it should be noted that the opening may take on various shapes rather than circular (e.g., any shape).

The perforated surface plate 562 may be attached to the housing 560 using any suitable means, as for example, bolts, screws, glues, adhesives, welds and the like. Furthermore, although the term perforated surface plate is used, it should be noted that it may be any perforated, porous or permeable membrane or membranes (e.g., laminate) whether rigid or flexible (does not have to be a plate). For example, the perforated surface plate 562 may take on a variety of forms including, but not limited to perforated, porous and/or permeable components such as sheets, screens, fabrics, filters or the like. Additionally or alternatively, the perforated surface plate may also take the form of woven, reticulated, fibrous or sintered components. The perforated surface plate may also be formed from a variety of materials as for example metals, plastics, ceramics, glass, cloth, composites, foams and the like. A metallic surface is generally preferred in industries where the buildup of a static electrical charge cannot be tolerated (e.g., semiconductor). In one particular embodiment, the perforated surface plate 562 is formed from a perforated sheet of stainless steel. In another embodiment, the perforated surface plate 562 is formed from sintered metal sheet, which may be bonded to a perforated metal sheet. By way of example, a sintered metal sheet that may be used is produced by Watt Corporation or Porvair Corporation.

With regards to the air sponge 564, the air sponge 564 is generally configured to provide a uniform and rigid mechanical support under the perforated surface plate 562 while also providing for unobstructed lateral flow to the perforated surface plate 562. That is, the air sponge 564 may physically support the thin porous or perforated surface plate in order to maintain a flat surface while providing very low resistance to air flow and very low pressure drop in all directions. The air sponge, thus, aids the uniform pressure drop distribution under the surface plate which occurs when the percentage of open area of the surface plate drops, as for example, when it drops below about 0.1 to about 0.2 percent.

As shown, the air sponge 564 is disposed inside the vacuum region 568 between the perforated vacuum plate 562 and a bottom of the housing 560 and between the sides of the housing 560. The position of the air sponge relative to the housing and perforated surface plate may be widely varied. For example, the top surface of the air sponge may or may not abut the perforated surface plate, the bottom surface of the air sponge may or may not abut the bottom, and the sides of the air sponge may or may not abut the sides of the housing. The top and bottom surfaces may be a portion of the air sponge, i.e., the air sponge may include recessed portions or it may be the entire top surface of the air sponge, i.e., the top surface may be planar as shown. In the illustrated, a top surface of the air sponge 564 abuts a bottom surface of the perforated surface plate 562 (supports the perforated surface plate). Further, the bottom surface of the air sponge is spaced away from the bottom of the housing. Further still, the sides of the air sponge extend to the sides of the housing.

The manner in which the air sponge 564 is situated may be widely varied. For example, the air sponge 564 may be attached directly or indirectly to the perforated surface plate 562, the housing 560 or some other member. The air sponge 564 may be attached using any suitable means, as for example, bolts, screws, glues, adhesives, welds and the like. Alternatively, the air sponge 564 may be unattached. For example, the perforated surface plate 560 may rest on the air sponge 564 and the air sponge 564 may rest on a support surface such as the bottom of the housing 560 or a rib that rests on the bottom surface of the housing 560 or a rib that is attached to some portion of the housing 560. In most cases, the air sponge 564 is physically supported by some portion of the housing 560 either directly or indirectly so that it may in turn support the perforated surface plate 562 in its desired position (e.g., level).

Furthermore, the air sponge 564 may take on a variety of forms including, but not limited to woven, reticulated, fibrous, sintered components or the like. The air sponge may also be formed from a variety of materials as for example metals, plastics, ceramics, glass, composites, foams and the like. In one embodiment, the air sponge 564 is formed from continuously connected fibers formed from metals, ceramics, plastics and the like. For example, the air sponge 564 may be formed from a Duocel foam manufactured by ERG Materials and Aerospace Corp. of Oakland, Calif. Duocel is the descriptive name given to a wide range of materials produced by ERG Materials and Aerospace Corporation (ERG). These materials exhibit a continuously connected, open celled (reticulated) geometry having a duodecahedronal cell shape. By way of example, the air sponge may be formed from open celled aluminum or vitreous carbon foam materials.

In one embodiment, the holding platform 558 is configured to produce a pressure drop that is uniformly distributed across the platform surface, and more particularly that is uniformly distributed across the platform surface while conveying the parts. As such, any number of parts may be moved without having to cover portions of the platform where parts are not located. The pressure drop and flow through the holding platform 558 may be widely varied. For example, the holding platform may be configured to produce a pressure drop across the surface plate of between about 1 to about 20 inches H₂O, and a flow through the surface plate of less than or equal to about 30 CFM per sq. foot.

With regards to the above described components, it is envisioned that dual variable flow blowers or vacuum pressure regenerative blowers may be used to create process airflows and pressures to air knives, holding platforms and the like. The MF573KS Multiflow Variable Flow Blower by AMETEK Rotron and the SKK 38203 vacuum pressure regenerative blower by Rietschle are examples of possible pressure sources. In addition, regenerative blowers by Becker may also be used. The system may be arranged to operate in an open loop with manual adjustments and flow meters sufficing or closed loop providing control and recipe download among other things.

Referring to FIGS. 11A-11D, the transfer units of the processing system 200 of FIG. 3 will be described in greater detail. FIG. 11A is a top view of the first transfer arm 231 moving a plurality of grouped chips 580 along a surface 582. As shown, each group of chips 580 is disposed in a pocket 233 of the first transfer arm 231. In addition, each group of chips 580 is pushed along the surface 582 by a lip 232 of the particular pocket in which it is positioned. In one embodiment, the lip 232 engages the chips closest to the lip 232 and after subsequent movement of the first transfer arm 231 pushes consecutive chips into abutment in the direction of movement (as shown). In so doing, a plurality of rows 584 are formed in each of the group of chips 580. The rows 584 are separated by gaps 586 formed during cutting.

The first transfer arm 231 may be widely varied. For example, different configurations of the transfer arm may be used to move different sized chips, different sized arrays of chips (2 by 2, 2 by 4, 4 by 4, 4 by 6, 6 by 6, 6 by 8, 8 by 8, 8 by 10, 10 by 10 and the like) and/or different number of chip groups (one or more). In the illustrated embodiment, the first transfer arm 231 includes 8 pockets which are capable of moving 8 4×4 arrayed groups. It should be appreciated, however, that if the chips size was reduced then a larger array of chips may be positioned in the pockets and if the chip size was increased then a smaller array of chips may be positioned in the pockets. Furthermore, if a single chuck was used then the first transfer arm may only include four pockets.

FIG. 11B is a top view of the second transfer arm 251 moving a plurality of chip rows 590 along a surface 592. As shown, each row of chips 590 is pushed along the surface 592 by a lip 252 of the second transfer arm 251. In one embodiment, the lip 252 engages the chips closest to the lip 252 and after subsequent movement of the second transfer arm 251 pushes consecutive groups of chips (as shown in FIG. 11A) into abutment in the direction of movement (as shown). In so doing, two groups 594A and 594B containing the plurality of rows 590 are formed. The rows 590 are separated by gaps 596 formed during cutting.

FIG. 11C is a top view of the third transfer arm 253 moving a single group of chips 600. As shown, the single group of chips 600 is formed by one of more rows of chips 602. The row of chips 602 are pushed together along a surface 604 by the lip 252 of the second transfer arm 253. In one embodiment, the lip 252 engages the row of chips closest to the lip 252 and after subsequent movement of the third transfer arm 253 pushes consecutive rows of chips (as shown in FIG. 11B) into abutment in the direction of movement (as shown). In so doing, one group 600 of tightly positioned chips is formed with substantially no gaps therebetween.

Although FIGS. 11B and 11C are shown as separate steps, it should be noted that they may be combined into one step. For example, the second and third transfer arms may be moved at the same time. In this particular case, the second transfer arm may move in the Y direction while the third transfer arm may move in the X direction thus compacting the chips in two directions at the same time.

FIGS. 11D and 11E are top views of the row indexer 310 moving distinct rows of chips 610A-C. The row indexer 310 is configured to move the distinct rows 610A-C through the vision inspection system and onto the rotate table. FIG. 11D shows the row indexer 310 in its initial position. As shown, the row indexer 310 is receiving a new row 610A from the row pusher 290. FIG. 11E, on the other hand, shows the row indexer 310 in its final position. As shown, the row indexer is in the middle of forming an 8×8 group of chips 612 on the rotate table.

The row indexer 310 may be widely varied, however, in FIGS. 11D and 11E, the row indexer 310 includes a plurality of fingers 614, each of which is configured to move one of the distinct row of chips 610A-C to a new position. For example, the fingers 614 are capable of moving rows of chips between a first position 616, a second position 618, a third position 620 and a fourth position 622. To elaborate, when the row indexer 310 is in route between its initial and final positions, the first row of chips 610A is moved from the first position 616 to the second position 618, the second row of chips 610B is moved from the second position 618 to the third position 620, and the third row of chips 610C is moved from the third position 620 to the fourth position 622. The first position 616 generally corresponds to the location where the row pusher 290 places a new set of chips 610D. The third position 620 generally corresponds to the location where vision inspection is implemented. The fourth position 622 generally corresponds to the location where the arrayed group 612 is formed. In the fourth position 622, each new row of chips abuts the previously positioned row of chips so as to form a single group (8×8 array). After the row indexer 310 has been moved between its initial and final position, it is picked up and moved back to the initial position to begin another sequence as described above.

In one embodiment, the third position of the row indexer 310 is a visual inspection position 620, i.e., the position where the chips are inspected for defects, imperfections and the like by the visual inspection system 300. In one implementation, the second lip 614B (the lip that moves the chips to the third position) includes a plurality of offset teeth 615 so as to form a staggered row of chips. As shown, each tooth 615 is configured to engage an individual chip for movement thereof, and each adjacent tooth is offset forward or backwards relative to its neighbor so as to form a staggered row, i.e., one chip is staggered forward, the other chip is staggered backwards, and so on. This is generally done so that the visual inspection system can recognize each of the chips during inspection. The staggered row of chips allows the vision inspection system to differentiate between chips (e.g., resolve the edges of the chips). As should be appreciated, if the chips were grouped in a row, the visual inspection system would have a hard time recognizing an individual chip inside the row. It should be noted that this is not a limitation and that the method of recognizing the chips may vary according to the specific needs of each device. For example, the second lip may be configured in a different pattern. It should be noted that the row indexer described in FIGS. 11D and 11E are not a limitation and that it may vary according to the specific needs of each system.

While this invention has been described in terms of several preferred embodiments, there are alterations, permutations, and equivalents, which fall within the scope of this invention. For example, although the different stations were described as being level with one another, this is not a limitation (the surfaces do not have to be level if there is a good reason for it to be otherwise). It should also be noted that there are many alternative ways of implementing the methods and apparatuses of the present invention. For example, although the invention has been described in terms of processing integrated circuits (in all its various forms), it should be noted that the invention may be used to process any device that may be slid along a flat surface, i.e., any device that has a flat surface. For example, the invention may be used to process quad flat devices (QFN) or discrete electrical components such as resistors, transistors, capacitors and the like. The invention may also be used to process biotechnological devices, optical devices, opto-electrical devices, electromechanical devices (e.g., MEMS-micro electromechanical) or the like. It is therefore intended that the following appended claims be interpreted as including all such alterations, permutations, and equivalents as fall within the true spirit and scope of the present invention.

What is claimed is:

1. A method of conveying integrated circuits, the method comprising:
providing a plurality of integrated circuits;
capturing the integrated circuits; and
sliding the integrated circuits along a surface.

2. The method as recited in claim 1 further including substantially retaining the integrated circuits relative to the surface so as to keep the integrated circuits in a desired movement path as they are slid along the surface.

3. The method as recited in claim 2 wherein the integrated circuits are retained by a cover.

4. The method as recited in claim 2 wherein the integrated circtuits are retained by a vacuum supplied through the surface.

5. The method as recited in claim 1 further including performing processing steps on the integrated circuits before, during or after the sliding.

6. The method as recited in claim 5 wherein the processing step is selected from a cleaning step, a visual inspection step, a part orientation step, a compacting step or a singulation step.

7. The method as recited in claim 6 wherein the cleaning step comprises:
washing the integrated circuits while the integrated circuits are slid along the surface; and
thereafter drying the integrated circuits while the integrated circuits are slid along the surface.

8. The method as recited in claim 6 wherein the compacting step comprises moving one or more integrated circuits into contact with one another

9. The method as recited in claim 1 wherein each of the integrated circuits are spaced apart from one another before sliding the integrated circuits along the surface

10. The method as recited in claim 1 wherein the integrated circuits are grouped in compacted rows before sliding the integrated circuits along the surface, the compacted rows being spaced apart from a neighboring row.

11. The method as recited in claim 1 wherein the integrated circuits are grouped in a compacted array before sliding the integrated circuits along the surface.

12. The method as recited in claim 1 wherein the integrated circuits are slid at the same time.

13. A process of making an integrated circuit, the process comprising:
providing a plurality of integrated circuits;
sliding the integrated circuits along a surface; and
performing a processing step on the integrated circuits.

14. The process as recited in claim 13 wherein the sliding is implemented incrementally.

15. The process as recited in claim 13 wherein the processing step is performed between increments.

16. The process as recited in claim 13 wherein the sliding is implemented continuously.

17. The process as recited in claim 13 wherein the processing step is performed while the integrated circuits are slid along the surface.

18. The process as recited in claim 13 wherein the processing step is selected from a cleaning step, a visual inspection step, a part orientation step, a compacting step or a singulation step.

19. The process as recited in claim 13 wherein the integrated circuits are chip scale packages

20. The process as recited in claim 13 wherein the integrated circuits are held in an ordered manner as they are slid along the surface.

21. The process as recited in claim 13 wherein the integrated circuits are compacted in a first direction as they are slid along the surface.

22. The process as recited in claim 21 wherein the integrated circuits are compacted in a second direction as they are slid along the surface.

23. The process as recited in claim 13 wherein the integrated circuits are substantially retained relative to the surface so as to keep the integrated circuits in a desired movement path as they are slid along the surface.

24. The process as recited in claim 13 further including providing a substrate and singulating the substrate into the plurality of integrated circuits.

25. The process as recited in claim 13 wherein the integrated circuits include a smooth side and wherein the integrated circuits are slid along the smooth side.

26. A chip scale package processing system, comprising:
a singulation station configured to dice a substrate into a plurality of chip scale packages, each of the chip scale packages having a smooth side;
a cleaning station configured to remove any debris that adhered to the chip scale packages during singulation;
a buffer station configured to provide a conveying area for the chip scale packages; and
a transfer arrangement configured to transport the chip scale packages through and between the various stations, wherein during transport the smooth side of the chip scale packages are slid along a surface.

27. The system as recited in claim 26 further including a chuck assembly arranged to hold the substrate and chip scale packages before, during and after singulation, wherein the chip scale packages are slid off of a surface of the chuck assembly after singulation.

28. The system as recited in claim 26 wherein the cleaning station includes a wash assembly configured to wash the chip scale packages and a dry assembly configured to dry the chip scale packages, and wherein the chip scale packages are slid along a washing surface during washing and a drying surface drying.

29. The system as recited in claim 26 wherein the transfer arrangement includes a first transfer arm configured to transport the chip scale packages from the singulation station to the cleaning station.

30. The system as recited in claim 29 wherein the first transfer arm is configured to transport the chip scale packages through the cleaning station.

31. The system as recited in claim 29 wherein the transfer arrangement includes a second and third transfer arm configured to transport the chip scale packages through the buffer station, and wherein the chip scale packages are slid along a surface of the buffer station during transportation therethrough.

32. The system as recited in claim 31 wherein the second and third transfer arms are configured to compact the chip scale packages.

33. The system as recited in claim 32 wherein the second transfer arm compacts the chip scale packages in a first direction and wherein the third transfer arm compacts the chips in a second direction.

34. The system as recited in claim 26 further including a vision inspection station configured to inspect each of the chip scale packages, and wherein the chip scale packages are slid along a vision inspection surface before and after inspection.

35. The system as recited in claim 26 further including a part orientation station configured to move the parts into proper orientation, and wherein the chip scale packages are slid along a orientation surface before and after the chip scale packages are oriented.

36. The system as recited in claim 26 further including an inversion station configured to invert the chip scale packages so that the smooth side of the chip scale packages can be picked by a pick and place machine.

37. The system as recited in claim 26 wherein the chip scale packages are substantially retained along the surface while being slid along the surface so as to prevent shingling of the chip scale packages.

38. A cleaning station for use in an integrated circuit processing system, comprising:
a wash assembly capable of distributing a fluid for washing integrated circuits that are moved along a washing surface; and
a dry assembly capable of removing moisture from integrated circuits that are moved along a drying surface.

39. The cleaning station as recited in claim 38 wherein the wash assembly includes a housing and a perforated surface plate, the perforated surface plate defining the washing surface, the housing and perforated surface plate cooperating to provide a fluid chamber where a cleaning solution is stored before distribution, the fluid chamber being coupled to a cleaning solution source that supplies the cleaning solution to the fluid chamber.

40. The cleaning station as recited in claim 39 wherein the cleaning solution is deionized water

41. The cleaning station as recited in claim 39 wherein the perforated surface plate includes a plurality of small openings for providing the cleaning solution therethrough.

42. The cleaning station as recited in claim 41 wherein the openings are small compared to the surface area of the integrated circuit.

43. The cleaning station as recited in claim 39 wherein the cleaning solution is caused to bubble above the perforated surface plate

44. The cleaning station as recited in claim 43 wherein the cleaning solution is allowed to flow above the integrated circuits when the integrated circuits are moved over the perforated surface plate.

45. The cleaning station as recited in claim 38 wherein the washing assembly further includes a gutter to collect the fluid.

46. The cleaning station as recited in claim 38 wherein the drying assembly includes a wet vacuum for sucking moisture away from the integrated circuits.

47. The cleaning station as recited in claim 46 wherein the wet vacuum includes a housing that defines the drying surface and includes one or more slots disposed therethrough, the housing also defining a negative pressure region, the negative pressure region being fluidly coupled to the one or more slots and a negative pressure source.

48. The cleaning station as recited in claim 47 wherein the slots are orthogonal to the drying surface

49. The cleaning station as recited in claim 47 wherein the slots are angled relative to the drying surface

50. The cleaning station as recited in claim 38 wherein the drying assembly includes an air blower for blowing moisture away from the integrated circuits.

51. The cleaning station as recited in claim 50 wherein the air blower includes a housing that defines the drying surface and includes one or more slots disposed therethrough, the housing also defining a positive pressure region, the positive pressure region being fluidly coupled to the one or more slots and a positive pressure source.

52. The cleaning station as recited in claim 51 wherein the slots form air knives

53. The cleaning station as recited in claim 51 wherein the slots are orthogonal to the drying surface

54. The cleaning station as recited in claim 51 wherein the slots are angled relative to the drying surface

55. A holding platform configured to allow movements of integrated circuits thereon, and to provide a retention force that helps maintain the moving integrated circuits in a desired position relative to one another during movements thereof.

56. The holding platform as recited in claim 55 wherein the retention force corresponds to a suction force.

57. The holding platform as recited in claim 56 wherein the holding platform includes a surface plate that allows movements of the integrated circuits thereon, and that distributes the suction force that helps maintain the moving integrated circuits in a desired position relative to one another during movements thereof.

58. The holding platform as recited in claim 57 wherein the surface plate is a perforated surface plate having a plurality of small openings for providing a vacuum therethrough.

59. The holding platform as recited in claim 58 wherein the openings of the perforated surface plate are small as compared to the surface area of the integrated circuit.

60. The holding platform as recited in claim 58 wherein the perforated surface plate is formed from sheets, screens, fabrics, or filters.

61. The holding platform as recited in claim 58 wherein the perforated surface plate is formed from metals, cloth, composites or foams.

62. The holding platform as recited in claim 58 wherein the perforated surface plate is formed from a perforated sheet of stainless steel.

63. The holding platform as recited in claim 55 further including an air sponge capable of controlling the vacuum through the perforated surface plate

64. The holding platform as recited in claim 63 wherein the air sponge is formed from continuously connected fibers that produce a uniform vacuum.

65. The holding platform as recited in claim 64 wherein the fibers are formed from metals, ceramics, or plastics.

66. The holding platform as recited in claim 63 wherein the air sponge is formed from Duocel foam

67. The holding platform as recited in claim 55 further including a housing that cooperates with the perforated surface plate to form a vacuum region, the vacuum region being configured to be coupled to a vacuum source.

68. The holding platform as recited in claim 67 further including an air sponge capable of controlling the vacuum through the perforated surface plate

69. The holding platform as recited in claim 68 wherein the air sponge is disposed inside the vacuum region between the perforated surface plate and a bottom of the housing.

70. The holding platform as recited in claim 69 wherein n the air sponge is positioned closer to the perforated surface plate.

71. The holding platform as recited in claim 55 wherein the retention force prevents shingling and side to side movements of the integrated circuits.

72. A dual vacuum chuck assembly for holding a pair of substrates and the integrated circuits formed therefrom before, during and after a singulation procedure, the dual vacuum chuck assembly comprising:
a first vacuum chuck having a first contact surface for receiving a first substrate, the first contact surface including a plurality of openings that provide a vacuum therethrough for holding the first substrate and the integrated circuits formed therefrom, each of the plurality of openings corresponding to an individually singulated integrated circuit, the first contact surface being configured to allow the integrated circuits to move thereon absent a substantial vacuum through the plurality of openings; and
a second vacuum chuck having a second contact surface for receiving a second substrate, the first contact surface including a plurality of second openings that provide a vacuum therethrough for holding the second substrate and the integrated circuits formed therefrom, each of the plurality of second openings corresponding to an individually singulated integrated circuit, the second contact surface being configured to allow the integrated circuits to move thereon absent a substantial vacuum through the plurality of second openings.

73. The dual chuck assembly as recited in claim 72 wherein the first and second contact surfaces are formed from a material that substantially seals the interface between the bottom surface of their respective substrates and integrated circuits when a sucking force is provided through the openings.

74. The dual chuck assembly as recited in claim 72 wherein the first and second contact surfaces are formed from a material with a low coefficient of friction so as to permit the integrated circuits to slide easily thereon.

75. The dual chuck assembly as recited in claim 72 further including a first plate and a second plate that combine to form a vacuum region, the first and second contact surfaces being attached to the first plate in a side by side relationship, the first plate having a plurality of openings that correspond to the openings of the first and second contact surfaces, the openings of the first plate extending to the vacuum region.
